(19) United States
(12) Patent Application Publication
(10) Pub. No.: US 2008/0303947 A1
(43) Pub. Date: Dec. 11, 2008

(54) Audio Processing Apparatus and Display Apparatus with Same

(75) Inventors: Sunao Ohnishi, Mie (JP); Tomoya Nakamura, Nara (JP); Hideyoshi Fukuoka, Tochigi (JP); Kenroh Sikada, Tochigi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA, Osaka-shi (JP)

(21) Appl. No.: 12/064,809

(22) PCT Filed: Aug. 25, 2006
(86) PCT No.: PCT/JP2006/316756

§ 371 Date: Aug. 5, 2008

(30) Foreign Application Priority Data
Aug. 26, 2005 (JP) 2005-245392
Aug. 26, 2005 (JP) 2005-246864
Aug. 25, 2006 (JP) 2006-229208

(51) Int. Cl. H04N 5/46; H04N 5/66

(52) U.S. Cl. 348/558; 348/739; 348/E05.114; 348/E05.133

(57) ABSTRACT

An AV device comprises a processing section for carrying out a process for view and listening, a signal output section for outputting a signal to the processing section, first signal input sections including a mobile audio input terminal, a first detecting section for detecting insertion/removal of a plug into/from the mobile audio input terminal, and a first control section for controlling the connection between the first signal input sections and the signal output section according to the result of the detection by the first detection section. Another AV device is provided in which insertion/removal of a plug into/from a second signal input section and indication information is outputted to a second video display section according to the detection result. With such constitutions, various processings can be carried out according to insertion/removal of a plug.

### BACKGROUND OF THE INVENTION

1. Field of the Invention

The present invention relates to AV (Audio Visual) apparatus. Specifically, the present inventions relates to an AV apparatus, which comprises an input terminal for mobile audio, and is capable of carrying out view processing according to plugging-in/unplugging at the input terminal for mobile audio.

2. Description of the Related Art

In recent years, viewing and listening styles have changed drastically. Users store large amount of compressed music files in various mobile music players (hereinafter, referred to as ‘mobile audio’) typified by MP3 (MPEG Audio Layer-3) player, and HDD (Hard Disk Drive) player, and view and listen to favorite music. Further, in recent years, audio content of a radio program etc. can be stored and updated by the mobile audio, thereby enjoying not only music but also audio content by the mobile audio. Thus, the mobile audio is establishing a presence as an archive center of user content.

The mobile audio is a mobile music player, and a user listens to music etc. by means of earphone or headphone etc. Here, in the case of listening to music stored in the mobile audio by means of a speaker of an external equipment with realistic and powerful sound at home, the mobile audio is connected with the AV apparatus such as a TV, and by utilizing a speaker of the TV, the user listens to the music at a loud volume.

In Unexamined Japanese Patent Application Publication No. 2002-185881, the invention relating to processing for the case where input source such as sound or video, inputted to the AV apparatus such as a TV, is varied is disclosed. In Unexamined Japanese Patent Application Publication No. 2002-185881, the invention relating to a control apparatus for information output, in which if the input source is varied, swift and easy shift to screen layout and to audio output mode, matching to user's taste, is carried out based on user's view history, is disclosed.

Further, in Unexamined Japanese Patent Application Publication No. 9-181992, a method, in which video muting is carried out just by connecting earphone to an earphone terminal in a television receiver, and only sound is reproduced, is disclosed.

However, in Unexamined Japanese Patent Application Publication No. 2002-185881, a technology relating only to the processing after the variation of the input source is disclosed, and a technology, in which variation of the input source is recognized and is utilized as a trigger for each processing, is not disclosed. Therefore, in cases where a plug is plugged-in as an input for different source, the plugging-in indicates that the user desires to vary the input source, but the disclosed technology cannot effectively utilize the plugging-in indicating user's intension. In addition, in Unexamined Japanese Patent Application Publication No. 9-181992, the sound outputted from the earphone is sound of TV broadcasting, not sound from the external electronic equipment.

Further, when connecting the AV apparatus and the external electronic equipment such as the mobile audio, and listening to music etc, there is a possibility for the user to forget that the external electronic equipment is connected after listening to music. Further, in case of setting of video muting during connection with the external electronic equipment, if the user forgets that the external electronic equipment and the AV apparatus are connected, and switches off the television receiver, screen display is not performed upon next power-on, and the user is bewildered.

In addition, in Unexamined Japanese Patent Application Publication No. 9-181992, the video muting is forcibly set when the earphone is connected with the earphone terminal, so that it is impossible to know information of operable key or of non-operable key of the television receiver during the video muting. Further, the video muting can be set by user's mistaken operation. In this case, it is impossible to immediately determine if the video muting is carried out, and there is a possibility that a user who is not familiar with operation misunderstands that it is a failure.

### SUMMARY OF THE INVENTION

It is an objective of the present invention to provide an AV apparatus, in which if the plugging-in/unplugging at the input terminal for external audio signal is detected, respective processes can be carried out according to the plugging-in/unplugging as an effective trigger, thereby improving usability.

In order to solve the above deficiencies, the present invention provides an AV apparatus, comprising, a processing unit, which carries out view processing, a signal output unit, which outputs a signal to the processing unit, a plurality of first signal input units, which include input terminal for mobile audio, a first detection unit, which detects plugging-in/unplugging at the input terminal for mobile audio, and a first control unit, which controls connection between the plurality of first signal input units and the signal output unit in accordance with a detection result by the first detection unit. According to the above configuration, it is possible to carry out various processes according to the plugging-in/unplugging.

In another aspect of the present invention, the first control unit may comprise connection means for mobile audio on priority basis, which connects the input terminal for mobile audio with output means for audio signal, which is for outputting an audio signal, in the signal output units in cases where the plugging-in has been detected in the first detection unit. According to the above configuration, it is possible to set the audio signal inputted from the mobile audio as a signal of audio output of the AV apparatus.

In another aspect of the present invention, the processing unit may comprise video muting means, which suspends the view processing of video signal in cases where the plugging-in has been detected in the first detection unit.

In another aspect of the present invention, the processing unit may comprise setting means for video muting, which carries out setting as to whether the view processing of video signal is suspended in the video muting means.

In another aspect of the present invention, a first video display unit including a backlight may be comprised, and the video muting means may comprise an energy-saving device, which switches off the backlight upon suspending the view processing of video signal.

In another aspect of the present invention, the video muting means may comprise a reduction device for brightness, which reduces brightness of the backlight upon suspending the view processing of video signal. According to the above configuration, it is possible to prevent unnecessary energy consumption.

In another aspect of the present invention, the processing unit may comprise video resuming means, which resumes the view processing of video signal in cases where the unplugging has been detected in the first detection unit.

In another aspect of the present invention, the processing unit may comprise modification means, which processes the video signal in cases where the video muting means suspends the view processing of video signal, and/or in cases where the video resuming means resumes the view processing of video signal.

In another aspect of the present invention, the processing unit may comprise setting means for cutoff of video signal, which carries out setting as to whether the view processing of video signal is suspended regardless of the detection of plugging-in, and may comprise setting means for video muting on priority basis, which nullifies the setting of the setting means for cutoff of video signal in cases where there are conflicts between the setting of the video muting means and the setting of the setting means for cutoff of video signal.

In another aspect of the present invention, a switching unit for video signal, which is for switching a video signal of a video, currently being viewed, to other video signal, is comprised, and the processing unit may comprise muting means upon switching, which carries out muting of audio signal upon switching in cases where the switching unit for video signal carries out switching, and nullification means for muting upon switching, which nullifies the function of the muting means upon switching so as not to carry out the muting of the audio signal regardless of the switching in cases where the plugging-in has been detected.

In another aspect of the present invention, a storage unit for video information, which stores a plurality of video information, is comprised, and the processing unit may comprise output means for stored video signal, which carries out the view processing of video signal by means of any one of the video information stored in the storage unit for video information in cases where the plugging-in has been detected in the first detection unit, and the setting of the setting means for video muting indicates that the view processing of video signal is not suspended.

In another aspect, the present invention provides an AV apparatus, comprising a second signal input unit, which is for input of an audio signal from an external electronic equipment through a plug, a second detection unit, which detects plugging-in/unplugging at the second signal input unit, a second video display unit, which is for displaying video content information, a sound output unit, which outputs sound based on the audio signal of the video content information, or on the audio signal inputted from the second signal input unit, and an output unit for notification information, which outputs notification information in order to carry out notification to a user based on the detection result by the second detection unit.

In another aspect, the present invention provides an AV apparatus, comprising a second control unit, which comprises control means for muting, which can control muting of display in the second video display unit in cases where the plugging-in has been detected in the second detection unit, and acquisition means for trigger signal for control, which acquires a trigger signal for control in order to control each unit, in which the second control unit has a function of controlling the above units, wherein the output unit for notification information further comprises output means for notification information dependent on trigger signal for control, which is for outputting the notification information based on a predetermined trigger signal for control acquired by the acquisition means for trigger signal for control.

In another aspect, the present invention provides an AV apparatus, comprising a switch unit, which transmits the trigger signal for control of each unit to the second control unit in accordance with operation, wherein the second control unit comprises restriction means, which nullifies the trigger signal for control, transmitted from the switch unit, other than a trigger signal for control regarding power or volume/sound during the muting control by the control means for muting

In another aspect of the present invention, the second video display unit comprises a backlight, and may comprise cancellation means for muting of backlight, which cancels all or part of muting control of the backlight in cases where the trigger signal for control, transmitted by the switch unit, is a trigger signal for control regarding volume/sound during the muting control by the control means for muting.

In another aspect of the present invention, the output means for notification information dependent on trigger signal for control may comprise an output device for notification information dependent on power-on, which displays notification information based on a power-on signal as a trigger signal for control.

In another aspect, the present invention provides an AV apparatus, wherein the output unit for notification information outputs the notification information in cases where the plugging-in has been detected in the second detection unit, and there is no audio signal inputted from a plug, plugged-in to the second signal input unit, for a predetermined period of time.

In another aspect, the present invention provides an AV apparatus, comprising a sound output unit, which outputs notification sound, wherein the output unit for notification information outputs the notification information to the sound output unit in place of or in addition to the output to the second video display unit.

Moreover, the present invention provides operation method for the above AV apparatus.

According to the AV apparatus of the present invention, if the plugging-in/unplugging at the input terminal for external audio signal is detected, respective processes can be carried out according to the plugging-in/unplugging as an effective trigger, thereby improving usability. For example, a setting for suspending process for viewing a video, or a setting as to whether the process for viewing is suspended can be carried out, thereby improving usability. In addition, it is possible to output indication and/or notification sound to the second video display unit in order to notify whether the AV apparatus and the external electronic equipment are connected, so that the user can easily confirm connection status of the externally connected device. In addition, it is also possible to determine whether or not a key is operable during connection with the external electronic equipment by means of the indication and/or notification sound in the second video display unit, thereby improving usability.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a conceptual diagram of a first embodiment;

FIG. 2 is a functional block diagram of the first embodiment;

FIG. 3 is another functional block diagram of the first embodiment;

FIG. 4 is a flowchart of a first embodiment;

FIG. 5 is a conceptual diagram of a second embodiment;

FIG. 6 is a functional block diagram of the second embodiment;

FIG. 7 is a flowchart of the second embodiment;

FIG. 8 is a functional block diagram of a third embodiment;

FIG. 9 is a flowchart of the third embodiment;

FIG. 10 is a functional block diagram of a fourth embodiment;

FIG. 11 is a flowchart of the fourth embodiment;

FIG. 12 is a functional block diagram of a fifth embodiment;

FIG. 13 is a flowchart of the fifth embodiment;

FIG. 14 is a functional block diagram of a sixth embodiment;

FIG. 15 is a diagram showing a screen display according to plugging-in/unplugging;

FIG. 16 is a flowchart of the sixth embodiment;

FIG. 17 is a functional block diagram of a seventh embodiment;

FIG. 18 is a diagram showing the modification of video;

FIG. 19 is a flowchart of the seventh embodiment;

FIG. 20 is a functional block diagram of an eighth embodiment;

FIG. 21 is a diagram showing conflicts between the setting for video muting and the setting for cutoff of video signal;

FIG. 22 is a flowchart of the eighth embodiment;

FIG. 23 is a functional block diagram of a ninth embodiment;

FIG. 24 is a flowchart of the ninth embodiment;

FIG. 25 is a functional block diagram of a tenth embodiment;

FIG. 26 is a flowchart of the tenth embodiment;

FIG. 27 is a conceptual diagram of an eleventh embodiment;

FIG. 28 is a functional block diagram of the eleventh embodiment;

FIG. 29 is a flowchart of the eleventh embodiment;

FIG. 30 is another flowchart of the eleventh embodiment;

FIG. 31 is a conceptual diagram of a twelfth embodiment;

FIG. 32 is a functional block diagram of the twelfth embodiment;

FIG. 33 is a flowchart of the twelfth embodiment;

FIG. 34 is a conceptual diagram of a thirteenth embodiment;

FIG. 35 is a functional block diagram of the thirteenth embodiment;

FIG. 36 is a flowchart of the thirteenth embodiment;

FIG. 37 is a conceptual diagram of a fourteenth embodiment;

FIG. 38 is a functional block diagram of the fourteenth embodiment;

FIG. 39 is a flowchart of the fourteenth embodiment;

FIG. 40 is a conceptual diagram of a fifteenth embodiment;

FIG. 41 is a functional block diagram of the fifteenth embodiment;

FIG. 42 is a flowchart of the fifteenth embodiment;

FIG. 43 is a conceptual diagram of a sixteenth embodiment; and

FIG. 44 is a functional block diagram of the sixteenth embodiment.

### DETAILED DESCRIPTION OF THE INVENTION

Embodiments of the present invention will be described hereinbelow with reference to the drawings. The present invention is not to be limited to the above embodiments and able to be embodied in various forms without departing from the scope thereof.

### First Embodiment

### <Concept of First Embodiment>

The first embodiment relates to an AV apparatus comprising signal input unit including an input terminal for mobile audio, which detects plugging-in/unplugging at the input terminal for mobile audio, and controls connection between the signal input unit and the signal output unit. Specifically, control of connection between the input terminal for mobile audio and an output means for audio signal, outputting an audio signal, of the signal output units is carried out.

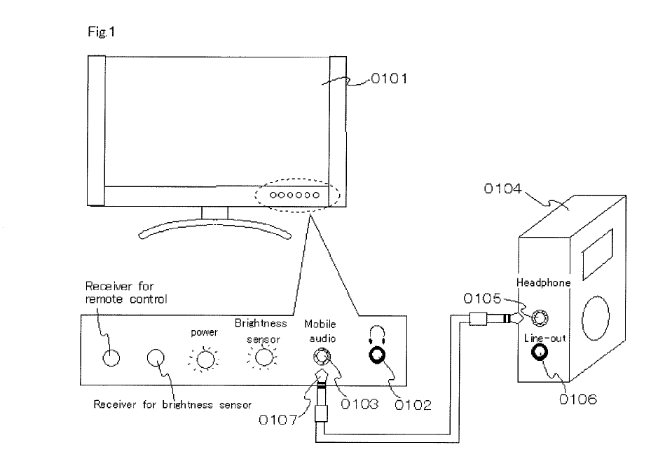

FIG. 1 is a conceptual diagram of a first embodiment. In FIG. 1, at the front of a LCD TV (0101), an input terminal for mobile audio (0103) indicated as ‘Mobile audio’ is provided adjacent to an audio output terminal (0102) for headphone. When plugging-in a plug (0107) of a cable connected to an output terminal such as a ‘headphone’ (0105) of a mobile audio (0104), or to a ‘line-out’ (0106) to this input terminal for mobile audio, sound outputted from a speaker device (not indicated) of the LCD TV is switched to sound outputted from the mobile audio. In another aspect, it is possible to switch video displayed on the LCD TV according to plugging-in to the input terminal for mobile audio, and this will be described from the second embodiment.

### <Configuration of First Embodiment>

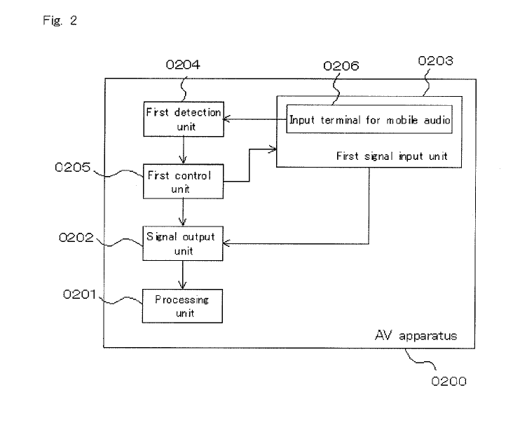

FIG. 2 is a functional block diagram of the first embodiment. In FIG. 2, an ‘AV apparatus’ (0200) of the first embodiment comprises a ‘processing unit’ (0201), a ‘signal output unit’ (0202), a ‘first signal input unit’ (0203), a ‘first detection unit’ (0204), and a ‘first control unit’ (0205).

Note that the respective units of the present invention are configured by hardware, software, or both hardware and software. For example, in the case of using a computer, the respective units are implemented by the hardware configured by a CPU, a memory, a bus, an interface, and other peripheral devices etc., and by the software operable on the hardware. Specifically, by sequentially carrying out programs on the memory, the data on the memory and the data inputted via the interface are processed, stored, and outputted etc., thereby implementing functions of the respective components (the same applies throughout the entire specification).

Example of the ‘AV apparatus’ (0200) include various television apparatuses such as a LCD TV and a plasma display panel TV, or component apparatus such as home theater. These apparatuses are usually placed in user's home, and they can output an audio signal at a loud volume, so that it is possible to listen to music stored in the mobile audio in an environment of loud volume by connecting the mobile audio to such AV apparatus.

The ‘processing unit’ (0201) carries out view processing. The term ‘view processing’ is a processing relating to video signal and to audio signal, outputted from the AV apparatus. For example, a processing for outputting video signal to a display screen of the AV apparatus, or a processing of audio signal for outputting from a speaker of the AV apparatus is carried out. Further, it is possible to carry out a processing to not output the video signal or the audio signal, or to modify the video signal or the audio signal. Specifically, the processing unit is configured by an output circuit for video signal, an output circuit for audio signal, a decoder, a CPU (Central Processing Unit), and a memory etc. The processing unit will be concretely described from the second embodiment.

The ‘signal output unit’ (0202) outputs a signal to the processing unit. The ‘signal’ includes video signal and audio signal. The after-mentioned signal input unit is connected to this signal output unit, thereby processing the inputted signal as an output signal of the AV apparatus. Specifically, the signal output unit is configured by terminal circuits such as output means for video signal, and output means for audio signal.

As to the ‘first signal input unit’ (0203), there are a plurality of first signal input units, which include an input terminal for mobile audio (0206). The ‘input terminal for mobile audio’ (0206) is an external input terminal for inputting an audio signal from the mobile audio to the AV apparatus. Here, the audio signal may be either an analog signal or a digital signal. Moreover, in an application (superimposing) method for a signal in the case of inputting the audio signal to the input terminal for mobile audio, the signal to be applied is not limited to an audio signal. Therefore, an audio signal and a control signal may be superimposed and applied together via one connection line. Alternatively, the audio signal and the control signal may be respectively inputted via individual connection lines and input terminals connected by means of a plurality of connection terminals. The same applies to all embodiments in this specification. The signal input unit includes various signal input units, which the AV apparatus normally comprises, in addition to the input terminal for mobile audio. For example, this ‘signal input unit’ includes a unit for inputting a signal to the AV apparatus such as a signal input unit for video signal or audio signal, acquired from an internal device of the AV apparatus such as a tuner, and a signal input unit for inputting an external video signal etc. from a video recorder or a DVD player. Although an arrangement of the first signal input unit in the AV apparatus is not limited, it is preferable that, specifically, the input terminal for mobile audio is arranged at the front of the AV apparatus as shown in FIG. 1. This arrangement makes it possible for a user to easily know the position of the input terminal for mobile audio, thereby improving usability of an external electronic equipment such as a mobile audio connected with the AV apparatus.

The ‘first detection unit’ (0204) detects plugging-in/unplugging at the input terminal for mobile audio (0206). The ‘plug’ corresponds to a plug, an end portion of a cable etc. to be connected to a headphone terminal or to a line-out terminal of the mobile audio. Examples of the plugging-include audio plugs of 3.5 mm and 5.5 mm, and specifically, the audio plug of 3.5 mm is preferable. The AV apparatus such as a TV becomes thinner, and the audio plug of 3.5 mm is used in many cases. The term ‘detects plugging-in/unplugging’ means a detection of plugging-in/unplugging. Specifically, the first detection unit collects predetermined signals from respective terminals periodically or constantly. When a plug is plugged-in, a terminal becomes LOW state, indicating a physical connection, and when the plug is plugging-in/unplugging, it becomes HIGH state, indicating disconnection, so that resistance value varies and the collected signal changes, thereby detecting plugging-in/unplugging.

The ‘first control unit’ (0205) controls connection between the plurality of first signal input units (0203) and the signal output unit (0202) in accordance with a detection result by the first detection unit (0204). The term ‘detection result by the first detection unit’ means a detection result of plugging-in to the input terminal for mobile audio, or a detection result of unplug from the input terminal for mobile audio. The term ‘controls connection between the plurality of first signal input units and the signal output unit’ means to carry out control as to which first signal input unit is connected to the signal output unit. For example, in cases where the AV apparatus is a TV, when viewing a normal TV program, the first signal input unit for inputting a video acquired by a tuner to the AV apparatus and the signal output unit are connected, so that the video signal and audio signal are sent to the processing unit, and are processed as output signals of the AV apparatus. Thus, a user views the normal TV program. In addition, when viewing a video, the external input unit for inputting a video outputted from video equipment to the AV apparatus and the signal output unit are connected, so that the video signal etc. can be processed as output signals of the AV apparatus. Another example of the control of connection between the plurality of first signal input unit and the signal output unit includes the case where the input terminal for mobile audio is connected to the output means for audio signal. The first control unit may carry out control to connect the signal output unit with a predetermined first signal input unit, or control to connect a predetermined first signal input unit with the signal output unit. Specifically, the first control unit (0205) is configured by a switch, and by a circuit for controlling the switch.

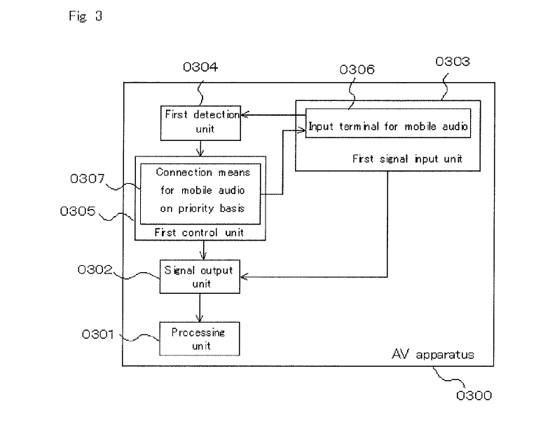

FIG. 3 is another functional block diagram of an AV apparatus (0300), wherein a first control unit (0305) further comprises ‘connection means for mobile audio on priority basis’ (0307). The ‘connection means for mobile audio on priority basis’ (0307) connects an input terminal for mobile audio (0306) with output means for audio signal, which is for outputting an audio signal, in signal output units (0302) in cases where the plugging-in has been detected in a first detection unit (0304). Accordingly, the audio signal outputted from the AV apparatus is audio signal inputted from the mobile audio. Therefore, it is possible to listen to large volumes of music stored in the mobile audio at a loud volume by means of the AV apparatus. Note that, as described above, the signal output unit includes output means for video signal, outputting a video signal, in addition to the output means for audio signal. Since the connection means for mobile audio on priority basis carries out connection process only for audio signal, control of connection not between the output means for video signal and the input terminal for mobile audio, but between the output means for video signal and another first signal input unit, is carried out. Therefore, for example, as to the audio signal, a signal inputted from the mobile audio can be outputted, and as to the video signal, a signal of a TV program inputted from a tuner can be outputted. Therefore, it is possible to view a normal TV program on a screen display of the AV apparatus listening to sound from the mobile audio.

### <Processing Flow of First Embodiment>

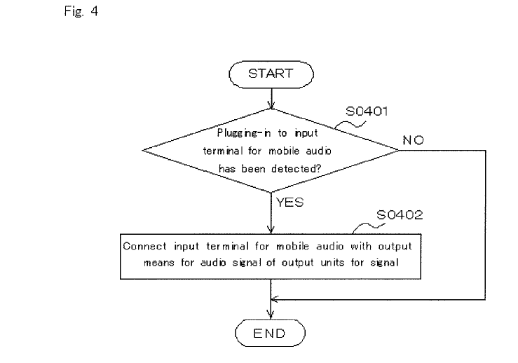

FIG. 4 is a flowchart of the first embodiment. The processing of the first embodiment comprises the following steps. Note that the following steps can be embodied as a program for causing a computer to execute the steps, or a readable recording medium storing the program (the same applies throughout the entire specification).

At the outset, it is determined whether plugging-in to the input terminal for mobile audio exists (S0401). In cases where the plugging-in to the input terminal for mobile audio has been detected in step S040 1, connection between the input terminal for mobile audio and the output means for audio signal, which is for outputting an audio signal, in the signal output units is carried out (S0402). Although FIG. 4 shows the case of plugging-in to the input terminal for mobile audio, it is possible to carry out processing for the case of unplugging, or processing of video signal in the case of plugging-in. These processes will be described in the second embodiment.

### <Brief Description of Effects of First Embodiment>

According to the AV apparatus of the first embodiment, control of connection between the first signal input unit and the signal output unit is carried out according to plugging-in/unplugging at the input terminal for mobile audio, so that it is possible to process the audio signal inputted from the input terminal for mobile audio as an output signal of the AV apparatus. In addition, the input terminal for mobile audio is connected only with output means for audio signal in the signal output units, so that it is possible, for example, to connect output means for video signal, which is for outputting a video signal, with the signal input unit for a signal from a tuner. Therefore, it is possible to listen to sound from the mobile audio viewing a normal TV program on a screen display of the AV apparatus. Therefore, it is possible to implement new life style, for example, listening to one's favorite music while viewing a video such as a predetermined landscape.

### Second Embodiment

### <Concept of Second Embodiment>

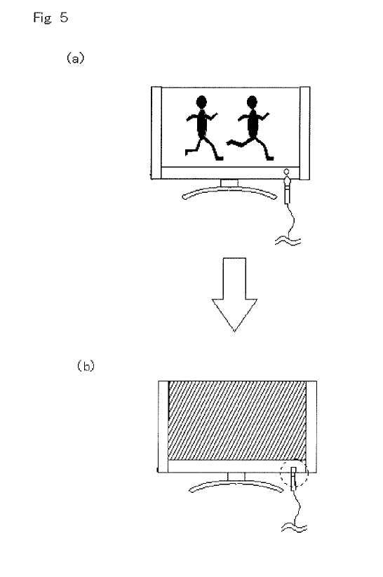

The second embodiment is an AV apparatus, which suspends the view processing of video signal in cases where the plugging-in to the input terminal for mobile audio has been detected. Specifically, muting process to not display a TV program etc., displayed before the plugging-in, can be carried out. Thus, the view processing of video signal is suspended, and unnecessary display process is not carried out, so that the user can enjoy listening to music from the mobile audio intensively. FIG. 5 is a conceptual diagram of a second embodiment. In FIG. 5(a), the user views a broadcast program by a LCD TV as the AV apparatus. Here, in the case of plugging-in to the input terminal for mobile audio, the view processing of video signal is suspended, thereby nothing is displayed on a display screen of the TV as shown in FIG. 5(b).

### <Configuration of Second Embodiment>

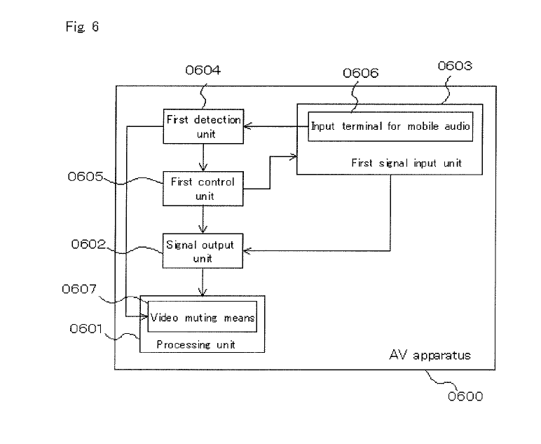

FIG. 6 is a functional block diagram of the first embodiment. In FIG. 6, an ‘AV apparatus’ (0600) of the second embodiment comprises a ‘processing unit’ (0601), a ‘signal output unit’ (0602), a ‘first signal input unit’ (0603), a ‘first detection unit’ (0604), and a ‘first control unit’ (0605). The ‘processing unit’ (0601) comprises ‘video muting means’ (0607).

In the second embodiment, the AV apparatus of the first embodiment further comprises the ‘video muting means’ (0607). Components other than the ‘video muting means’ (0607) are the same as those of the first embodiment, so that descriptions are omitted.

The ‘video muting means’ (0607) suspends the view processing of video signal in cases where the plugging-in has been detected in the first detection unit. The term ‘in cases where the plugging-in has been detected in the first detection unit’ means the case where the plugging-in to the input terminal for mobile audio has been detected. The term ‘view processing of video signal’ is, for example, a processing for outputting video signal, sent from the signal input unit connected with the output means for audio signal, which is for outputting an audio signal, in the signal output units. To ‘suspend’ the view processing of video signal means that the video is not displayed on the display screen of the AV apparatus, or the video to be displayed on the display screen in normal case is not displayed by reducing brightness. For example, a video signal to be outputted is masking-processed, so that the video signal from the tuner is not displayed on the display screen, or brightness of the video signal to be outputted is drastically reduced, so that a black or half-light video image is displayed on the display screen. Therefore, by this masking-process of the video signal, video of a TV program etc. is not displayed on the TV screen during listening to music from the mobile audio, so that the user can intensively listen to music. Further, other than the masking-process, for example, the first control unit may carry out control to not connect video signal from the tuner to the signal output unit, thereby suspending the view processing of the video signal. Note that the ‘video muting’ is to not display a video on the screen by carrying out the masking-process of the video signal. Note that, as described in other embodiments, the ‘video muting’ includes a processing for reducing the brightness, thereby displaying the black video image, and a processing for switching-off the backlight.

### <Processing Flow of Second Embodiment>

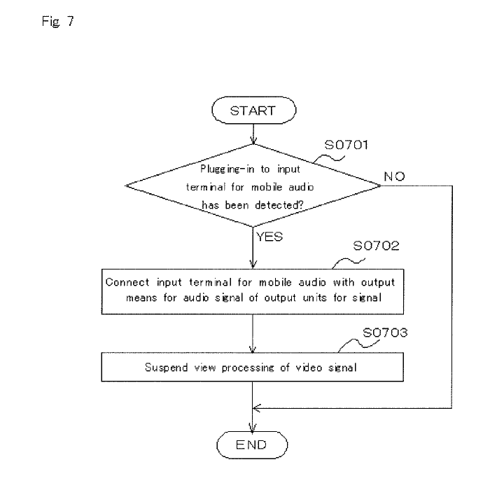

FIG. 7 is a flowchart of the second embodiment. The processes up to step S0702 are the same as those of the first embodiment, so that descriptions are omitted. In step S0703, a processing for suspending the view processing of video signal is carried out. Note that step S0702 and S0703 may be carried out in reverse order.

### <Brief Description of Effects of Second Embodiment>

In the AV apparatus of the second embodiment, the view processing of video signal is suspended in cases where the plugging-in to the input terminal for mobile audio has been detected, so that it is possible to not display video of the content on the display screen of the AV apparatus when listening to music from the mobile audio. Therefore, it is possible to not display a video mismatching to the sound (music) outputted from the AV apparatus, so that the user can intensively listen to the music from the mobile audio.

### Third Embodiment

### <Concept of Third Embodiment>

The third embodiment is an AV apparatus, which switches off the backlight in the case of suspending the view processing of video signal described in the second embodiment. By switching off the backlight, it is possible to prevent unnecessary energy consumption, thereby providing an AV apparatus, which can promote energy-savings.

### <Configuration of Third Embodiment>

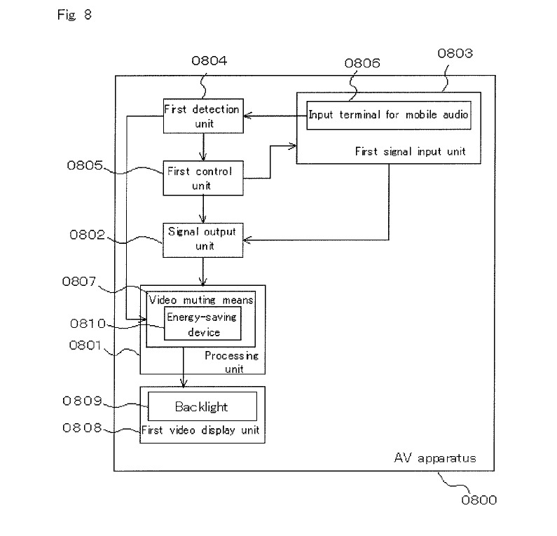

FIG. 8 is a functional block diagram of the third embodiment. In FIG. 8, an ‘AV apparatus’ (0800) of the third embodiment comprises a ‘processing unit’ (0801), a ‘signal output unit’ (0802), a ‘first signal input unit’ (0803), a ‘first detection unit’ (0804), a ‘first control unit’ (0805), and a ‘first display unit’ (0808). The ‘processing unit’ (0801) comprises a ‘video muting means’ (0807). The ‘video muting means’ (0807) further comprises a ‘energy-saving device’ (0810).

In the third embodiment, the AV apparatus of the second embodiment further comprises the ‘first display unit’ (0808), and the ‘energy-saving device’ (0810). The other components other than the ‘first display unit’ (0808) and the ‘energy-saving device’ (0810) are the same as those of the second embodiment, so that descriptions are omitted.

The ‘first display unit’ (0808) includes a backlight (0809). The ‘first display unit’ is for displaying a video, and specifically, is a LCD display. On the first display unit, for example, a broadcast program received by a tuner of the AV apparatus, and a video of a video content stored in DVD etc. are displayed. The ‘backlight’ (0809) is a light source for displaying a video on the first display unit. As a result of backlighting, the video can be displayed on the first display unit.

The ‘energy-saving device’ (0810) switches off the backlight upon suspending the view processing of video signal. The term ‘upon suspending the view processing of video signal’ include the case of execution at the same time of the video muting described in the second embodiment, and the case of execution after a predetermined period of time (e.g. 5 seconds) from video muting of video signal. The term ‘switches off the backlight’ means to stop power supply to the light source. By switching off the backlight upon suspending the view processing of video signal, it is possible to save electricity of the backlight, thereby extending the life of the backlight. Therefore, by switching off the backlight, it is possible to improve energy-savings, and to reduce costs. In addition, in the case of switching off the backlight, on-screen display (OSD) of an indication as to the video muting may be carried out on the screen under video muting. By this indication as to the video muting, the user can expect the suspension of display.

### <Processing Flow of Third Embodiment>

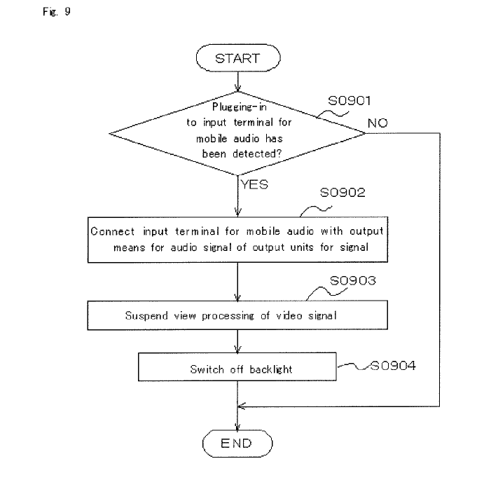

FIG. 9 is a flowchart of the third embodiment. The processes up to step S0903 are the same as those of the second embodiment, so that descriptions are omitted. In step S0904, the backlight is switched off. After that, in cases where a predetermined request is sent from the user via the remote control, the backlight may be switched on in order to carry out screen display in response to the request.

### <Brief Description of Effects of Third Embodiment>

In the AV apparatus of the third embodiment, switching off the backlight is carried out upon suspending the view processing of video signal, so that it is possible to not provide unnecessary information for the user, and the user can intensively listen to the music from the mobile audio. In addition, it is possible to prevent unnecessary energy consumption, thereby providing an AV apparatus, which can improve energy-savings.

### Fourth Embodiment

### <Concept of Fourth Embodiment>

The fourth embodiment is an AV apparatus, which reduces brightness of the backlight upon suspending the view processing of video signal. The brightness of the backlight is reduced and the backlight is not switched off, so that it is possible to improve response in the case of immediately lighting-on, and to listen to music while viewing a video with the atmosphere of half-light, not complete blackness.

### <Configuration of Fourth Embodiment>

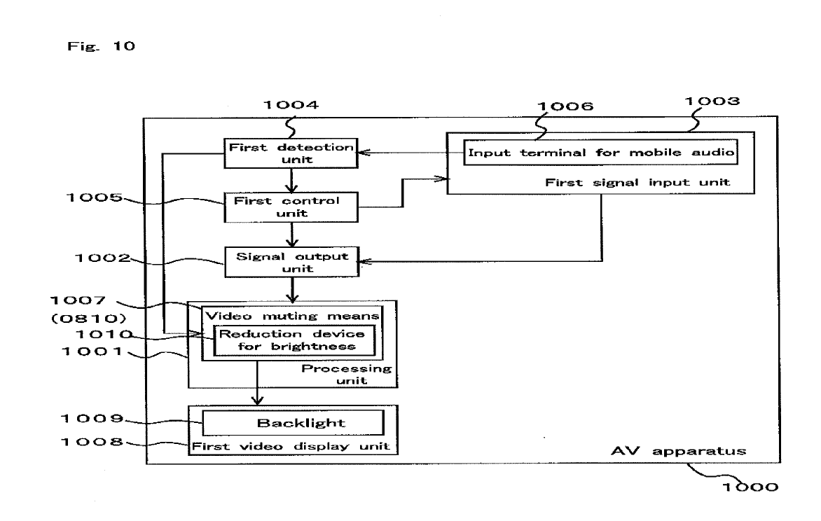

FIG. 10 is a functional block diagram of a fourth embodiment. In FIG. 10, an ‘AV apparatus’ (1000) of the fourth embodiment comprises a ‘processing unit’ (1001), a ‘signal output unit’ (1002), a ‘first signal input unit’ (1003), a ‘first detection unit’ (1004), a ‘first control unit’ (1005), and a ‘first display unit’ (1008). The ‘processing unit’ (1001) comprises a ‘video muting means’ (1007). The ‘video muting means’ (1007) further comprises a ‘energy-saving device’ (0810).

In the fourth embodiment, the AV apparatus of the second embodiment further comprises the ‘first display unit’ (1008), and the ‘reduction device for brightness’ (1010). The ‘first display unit’ (1008) is the same as that of the third embodiment. The other components other than the ‘first display unit’ (1008) and the ‘reduction device for brightness’ (1010) are the same as those of the second embodiment, so that descriptions are omitted.

The ‘reduction device for brightness’ (1010) reduces brightness of the backlight upon suspending the view processing of video signal. The term ‘reduces brightness of the backlight’ means that, for example, in the case of a backlight using a fluorescent tube, driving voltage applied to the fluorescent tube is reduced, thereby reducing the brightness, or in the case of an LED backlight using a plurality of LEDs (light-emitting diode), driving current is reduced, thereby reducing the brightness of the display. For example, it is possible to reduce brightness by controlling PWM (Pulse Width Modulation) for oscillation of an inverter circuit for driving a fluorescent tube for lighting of the backlight. Specifically, by reducing duty-ratio of pulse width for controlling lighting time, it is possible to reduce brightness. Thus, in cases where the backlight is not completely switched off, it is possible to immediately carry out re-lighting up of the backlight next time, thereby improving response. Moreover, by reducing the brightness of the backlight, a half-light video is displayed on the screen, so that it is possible to listen to music while viewing a video such as an occult film with atmosphere of half-light, not complete blackness. Moreover, a storage medium for storing a setting of brightness may be provided with the AV apparatus, and reduction of the brightness may be carried out based on the stored setting of brightness upon next plugging-in.

### <Processing Flow of Fourth Embodiment>

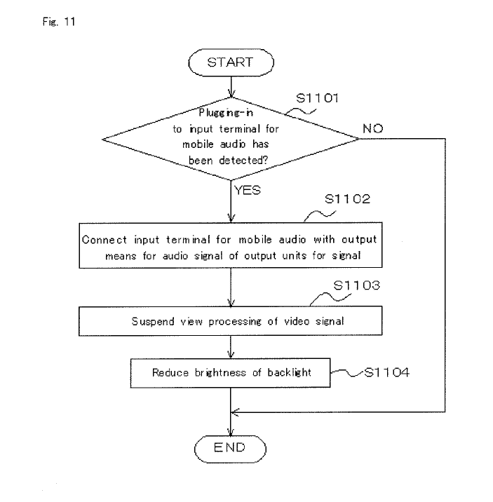

FIG. 11 is a flowchart of the fourth embodiment. The processes up to step S1103 are the same as those of the second embodiment, so that descriptions are omitted. In step S1104, the brightness of the backlight is reduced. After that, in cases where a predetermined request is sent from the user via the remote control, the brightness of the backlight may be increased in order to carry out screen display in response to the request.

### <Brief Description of Effects of Fourth Embodiment>

In the AV apparatus of the fourth embodiment, brightness of the backlight is reduced upon suspending the view processing of video signal. The brightness of the backlight is reduced and the backlight is not switched off, so that it is possible to improve response of lighting-up next time. Moreover, by reducing the brightness of the backlight, a half-light video is displayed on the screen, so that it is possible to listen to music viewing a video with atmosphere of half-light, not complete blackness.

### Fifth Embodiment

### <Concept of Fifth Embodiment>

The fifth embodiment is an AV apparatus, which can carries out setting as to whether the view processing of video signal is suspended in the video muting means. Some users desire to view various broadcast programs such as a news program, a sports program, or a TV program while traveling by train listening to music from the mobile audio. Here, by enabling a setting as to whether the view processing of video signal is suspended in the video muting means, flexibility for users is provided, and usability is improved.

### <Configuration of Fifth Embodiment>

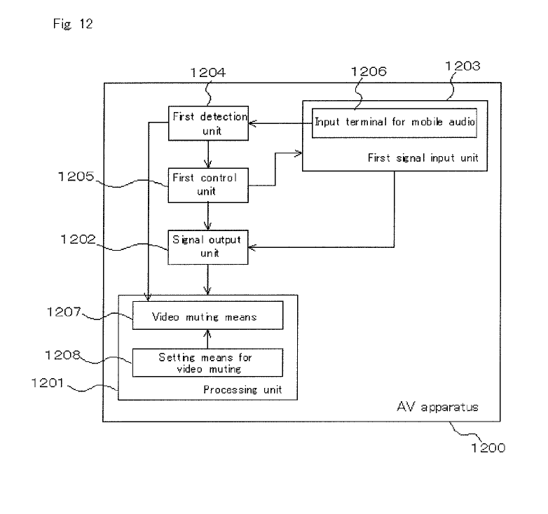

FIG. 12 is a functional block diagram of the fifth embodiment. In FIG. 12, an ‘AV apparatus’ (1200) of the fifth embodiment comprises a ‘processing unit’ (1201), a ‘signal output unit’ (1202), a ‘first signal input unit’ (1203), a ‘first detection unit’ (1204), and a ‘first control unit’ (1205). The ‘processing unit’ (1201) comprises ‘video muting means’ (1207), and a ‘setting means for video muting’ (1208).

In the fifth embodiment, the AV apparatus described in any one of the second to fourth embodiments further comprises the ‘setting means for video muting’ (1208). Components other than the ‘setting means for video muting’ (1208) are the same as those described in any one of the second to fourth embodiments, so that descriptions are omitted.

The ‘setting means for video muting’ (1208) carries out setting as to whether the view processing of video signal is suspended in the video muting means (1207). The above-mentioned video muting means suspends the view processing of video signal in cases where the plugging-in has been detected in the first detection unit, therefore, in cases where the plugging-in to an input terminal for mobile audio (1206) has been detected in the first detection unit. The setting means for video muting (1208) of the fifth embodiment carries out setting as to whether the view processing of video signal is suspended. In the case of setting not to suspend the view processing of video signal, display of the video, currently being displayed, is continued even if the plugging-in is detected. Specifically, if the plugging-in has been detected, the CPU reads a flag for setting of video muting, stored in a predetermined memory area, and the video muting means (1207) carries out subsequent processing in accordance with the flag for setting of video muting. For example, in cases where a bit indicated by the flag for setting of video muting is 1, the video muting is carried out. Meanwhile, in cases where a bit indicated by the flag for setting of video muting is 0, the video muting is not carried out. Thus, by the setting means for video muting, it is possible to carry out setting as to whether the video muting is carried out. Therefore, in cases where the user desires only to listen to music from the mobile audio, suspending of the view processing of video signal is set. Meanwhile, in cases where the user desires to listen to music from the mobile audio while viewing a video, not suspending of the view processing of video signal is set. Therefore, the user can enjoy listening to music from the mobile audio as the user likes. For example, many contents such as a sports program, which can be enjoyed just by video, are broadcasted, and when viewing such contents, the user can enjoy some contents at the same time by listening to music stored in the mobile audio.

### <Processing Flow of Fifth Embodiment>

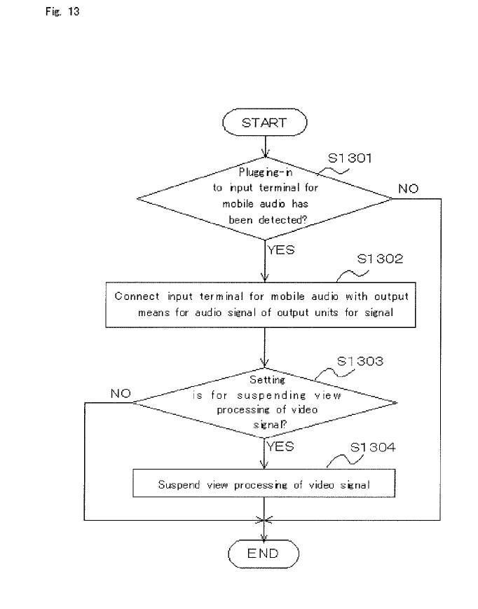

FIG. 13 is a flowchart of the fifth embodiment. The processes up to step S1302 are the same as those in any one of the second to fourth embodiments, so that descriptions are omitted. In step S1303, it is determined whether the setting indicates suspending of the view processing of video signal. In step S1303, in cases where it is determined that the setting indicates suspending of the view processing of video signal, in step S1304, the view processing of video signal is suspended. Meanwhile, in step S1303, in cases where it is determined that the setting does not indicate suspending of the view processing of video signal, in step S1304, the view processing of video signal is carried on.

### <Brief Description of Effects of Fifth Embodiment>

In the AV apparatus of the fifth embodiment, by enabling a setting as to whether the view processing of video signal is suspended, flexibility for users is provided, and usability is improved. Therefore, considering the case of plugging-in from the mobile audio to the AV apparatus in order to listen to music from the mobile audio at a loud volume, there can be various users such as a user who desires to view the video currently being displayed on the AV apparatus, or a user who does not desire to display the video for energy-savings. Here, by utilizing the AV apparatus of the fifth embodiment, needs of both users can be satisfied, thereby improving usability.

### Sixth Embodiment

### <Concept of Sixth Embodiment>

The sixth embodiment is an AV apparatus, which resumes the view processing of video signal upon unplugging in cases where the plugging-in to the input terminal for mobile audio has been detected, and the video muting is carried out. Since the display of the video is resumed according to the unplugging as a trigger, if the user desires to view the video again by the AV apparatus, all the user need to do is unplug it. Therefore, it is possible to view the video without a complicated operation.

### <Configuration of Sixth Embodiment>

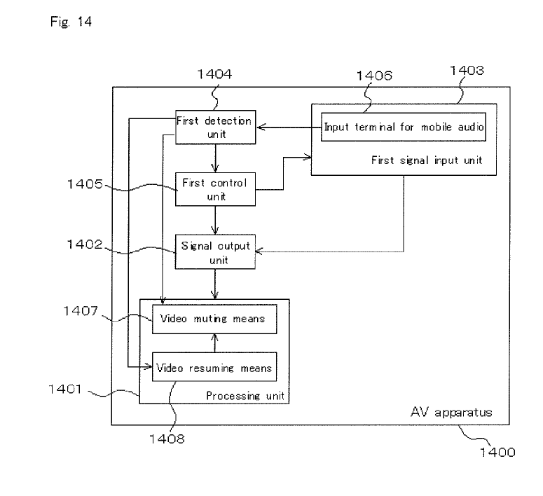

FIG. 14 is a functional block diagram of the sixth embodiment. In FIG. 14, an ‘AV apparatus’ (1400) of the sixth embodiment comprises a ‘processing unit’ (1401), a ‘signal output unit’ (1402), a ‘first signal input unit’ (1403), a ‘first detection unit’ (1404), and a ‘first control unit’ (1405). The ‘processing unit’ (1401) comprises ‘video muting means’ (1407), and ‘video resuming means’ (1408).

In the sixth embodiment, the AV apparatus described in any one of the second to fifth embodiments further comprises the ‘video resuming means’ (1408). Components other than the ‘video resuming means’ (1408) are the same as those described in any one of the second to fifth embodiments, so that descriptions are omitted.

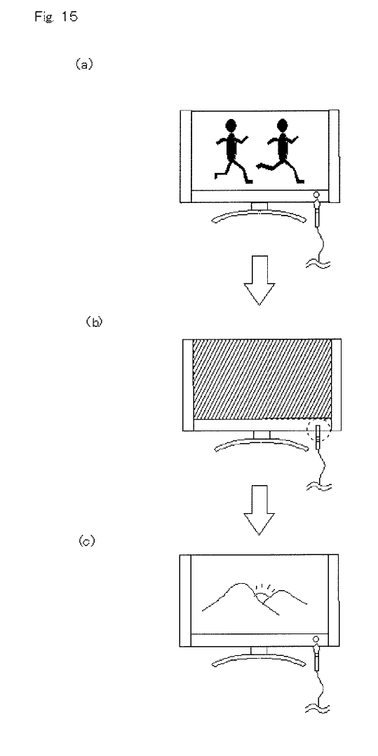

The ‘video resuming means’ (1408) resumes the view processing of video signal in cases where the unplugging has been detected in the first detection unit. The term ‘the unplugging has been detected in the first detection unit’ means that the unplugging is detected under a state of plugging-in to the input terminal for mobile audio. The detection of the unplugging is carried out as described above. Therefore, the first detection unit collects predetermined signals from respective terminals periodically or constantly. When a plug is plugged-in, a terminal becomes LOW state, indicating physical connection, and when the plug is plugged-out, it becomes HIGH state, indicating disconnection, so that resistance value varies and the collected signal changes, thereby detecting plugging-in/unplugging. The term ‘resumes the view processing of video signal’ means that the view processing of video signal is carried out again in cases where the view processing of video signal is suspended by the above-mentioned ‘video muting means’ (1407). FIG. 15 is a diagram showing a concept of the sixth embodiment. In FIG. 15(a), a user views a TV program. In the case of plugging-in to the input terminal for mobile audio in order to listen to music from the mobile audio, the video muting is carried out as shown in FIG. 15(b). After that, in the case of unplug, the video of the program is displayed again. Since there is a time-lag between FIG. 15(a) and 15(c), the displayed video is different. Note that, under the setting of the setting means for video muting described in the fifth embodiment, which indicates to not carry out video muting, in where the unplugging is detected, the display of the video, currently being displayed, is carried on.

Note that, in cases where the video muting is carried out, and changing of channel of TV program is carried out in the background, the video to be resumed according to the detection of plugging-in may be a video of a channel after the changing of channel. Thus, the view processing of video signal is resumed according only to the unplugging, so that it is possible to view the video again without causing a special operation for the user.

### <Processing Flow of Sixth Embodiment>

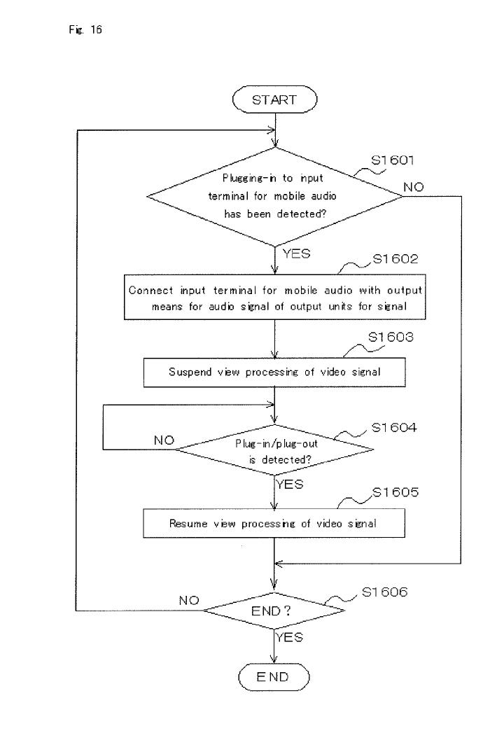

FIG. 16 is a flowchart of the sixth embodiment. The processes up to step S1603 are the same as those in any one of the second to fifth embodiments, so that descriptions are omitted. In step S1604, it is determined whether the unplugging has been detected. In cases where it is determined in step S1604 that the unplugging has been detected, in step S1605, the view processing of video signal is resumed. Meanwhile, in cases where it is determined in the step S1604 that the unplugging has not been detected, the detection of the unplugging may be awaited, or the processing may be terminated in the case of power-off of the AV apparatus.

### <Brief Description of Effects of Sixth Embodiment>

The AV apparatus of the sixth embodiment can resume the view processing of video signal in cases where the unplugging from the input terminal for mobile audio has been detected in the first detection unit. Therefore, if the user desires to view the TV program again after listening to music from the mobile audio, the user can view the TV program again only by unplugging of the plugged-in plug. Accordingly, it is possible for the user to listen to music from the mobile audio, or to view the video without complicated operation, thereby improving usability.

### Seventh Embodiment

### <Concept of Seventh Embodiment>

The seventh embodiment is an AV apparatus, which modifies the video signal so as to implement various effects such as fade-in or fade-out of the screen in cases where the video muting is carried out, or in cases where the resuming of the video from the video muting state is carried out.

### <Configuration of Seventh Embodiment>

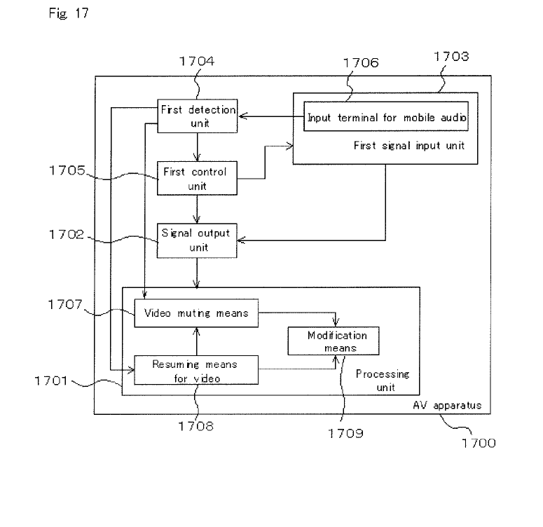

FIG. 17 is a functional block diagram of the seventh embodiment. In FIG. 17, an ‘AV apparatus’ (1700) of the seventh embodiment comprises a ‘processing unit’ (1701), a ‘signal output unit’ (1702), a ‘first signal input unit’ (1703), a ‘first detection unit’ (1704), and a ‘first control unit’ (1705). The ‘processing unit’ (1701) comprises ‘video muting means’ (1707), and ‘video resuming means’ (1708), and ‘modification means’ (1709).

In the seventh embodiment, the AV apparatus described in the sixth embodiment further comprises the ‘modification means’ (1709). Components other than the ‘modification means’ (1709) are the same as those described in the sixth embodiments, so that descriptions are omitted.

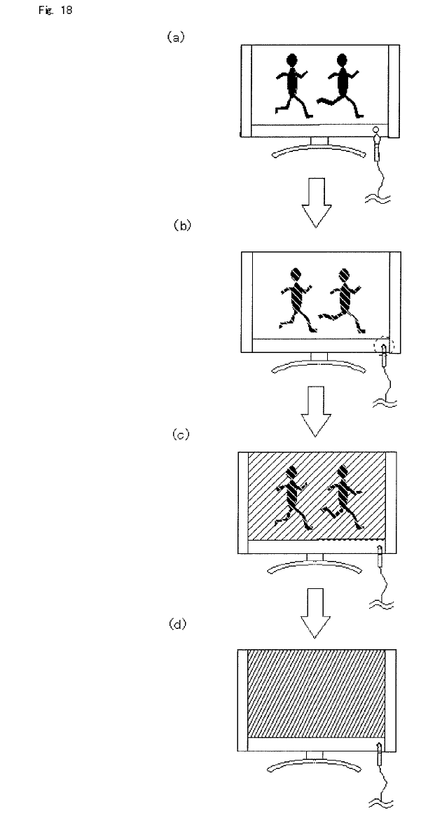

The ‘modification means’ (1709) modifies the video signal in cases where the video muting means suspends the view processing of video signal, and/or in cases where the video resuming means resumes the view processing of video signal. The term ‘modifies the video signal’ means, for example, processing for the fade-in or fade-out. The fade-in is a video effect, in which brightness of displayed video is gradually increased, and the fade-out is a video effect, in which brightness of displayed video is gradually reduced. Specifically, according to detection of plugging-in/unplugging, intensity of brightness signal of video signal is adjusted, thereby implementing the fade-in or fade-out. For example, in the case of plugging-in to the input terminal for mobile audio, the fade-out is carried out upon video muting, or in the case of unplugging from the input terminal for mobile audio during the video muting, the fade-in is carried out. FIG. 18 is a diagram showing the modification of video. FIG. 18(a) shows a state in which a TV program is displayed on the display screen of the AV apparatus. In the case of plugging-in to the input terminal for mobile audio, as shown in FIGS. 18(b), 18(c), and 18(d), the modification of the video signal for a video to be displayed on the screen is carried out, thereby the video gradually disappears.

Although the fade-in and the fade-out have been described as examples of the modification of the video signal, other modifications can be carried out. For example, in cases where the view processing of video signal is suspended, the video muting may be carried out after making a screen near-white by enhancing the brightness signal of the video signal. Alternatively, in cases where the view processing of video signal is resumed, normal screen display may be carried out by gradually blackening the screen after displaying a white screen by enhancing the brightness components of the video signal.

### <Processing Flow of Seventh Embodiment>

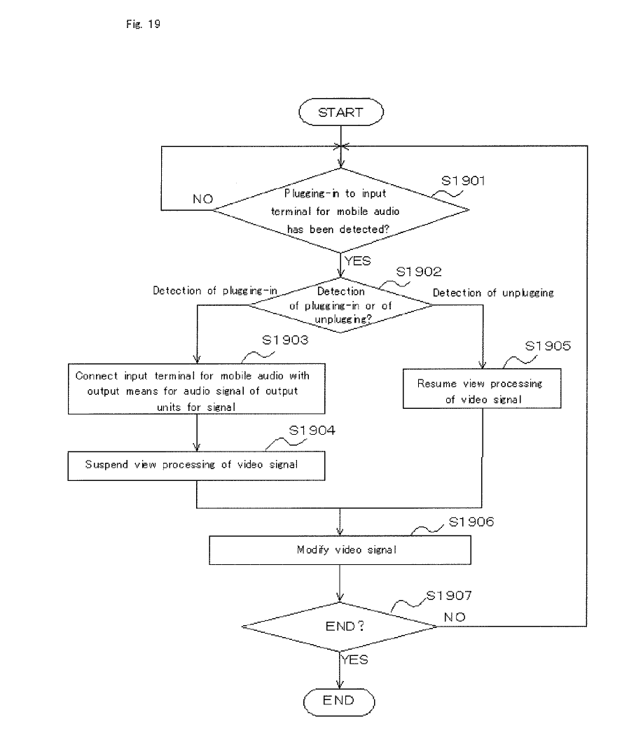

FIG. 19 is a flowchart of the seventh embodiment. In step S1901, it is determined whether the plugging-in/unplugging at the input terminal for mobile audio has been detected. In cases where the plugging-in/unplugging has been detected, in step S1902, a processing is carried out according to whether plugging-in or unplugging has been detected. In cases where plugging-in has been detected, processing flows to steps S1903, and to S1904. Meanwhile, in cases where unplugging has been detected, processing flows to step S1905. The processes of steps S1903 to S1905 are the same as those of the sixth embodiment. After that, whichever step has been carried out, the processing flows to step S1906, and modification of the video signal is carried out.

### <Brief Description of Effects of Seventh Embodiment>

The AV apparatus of the seventh embodiment modifies the video signal in cases where the video muting means suspends the view processing of video signal, and/or in cases where the video resuming means resumes the view processing of video signal, so that it is possible to vary the video according to the plugging-in/unplugging at the input terminal for mobile audio. Therefore, the other user who does not operate the plugging-in/unplugging can view the change of video, thereby improving usability for the user.

### Eighth Embodiment

### <Concept of Eighth Embodiment>

The eighth embodiment is an AV apparatus, which carries out setting as to whether the view processing of video signal is suspended regardless of the detection of plugging-in to the input terminal for mobile audio, and gives priority to the setting of video muting in cases where there are conflicts between the setting of the video muting according to the detection result of the plugging-in to the input terminal for mobile audio and the setting of the same function as the video muting. In the case of viewing a TV program or a music DVD such as a music video, there is a user who enjoys only sound without displaying any video, and there is a case where a function for such user to not display a video is normally provided. In the eighth embodiment, the setting of the video muting according to the detection result of the plugging-in to the input terminal for mobile audio is carried out on a priority basis in cases where there are conflicts between the setting of this normally provided function to not display a video and the setting of the video muting according to the detection result of the plugging-in to the input terminal for mobile audio.

### <Configuration of Eighth Embodiment>

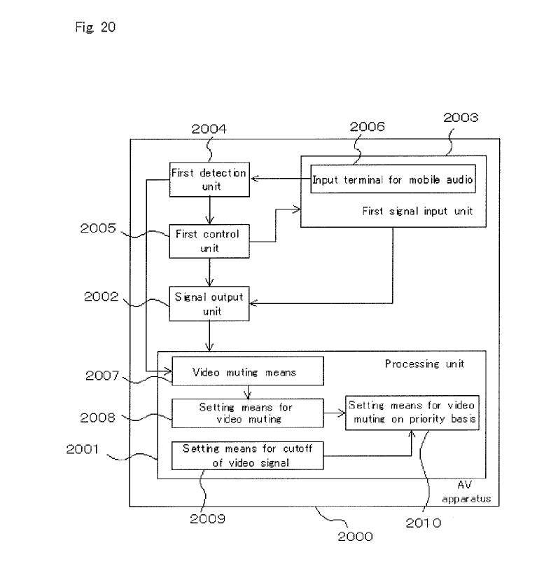

FIG. 20 is a functional block diagram of the eighth embodiment. In FIG. 20, an ‘AV apparatus’ (2000) of the seventh embodiment comprises a ‘processing unit’ (2001), a ‘signal output unit’ (2002), a ‘first signal input unit’ (2003), a ‘first detection unit’ (2004), and a ‘first control unit’ (2005). The ‘processing unit’ (2001) comprises ‘video muting means’ (2007), ‘setting means for video muting’ (2008), ‘setting means for cutoff of video signal’ (2009), and ‘setting means for video muting on priority basis’ (2010).

In the eighth embodiment, the AV apparatus described in the fifth to seventh embodiments further comprises the ‘setting means for cutoff of video signal’ (2009), and a ‘setting means for video muting on priority basis’ (2010). The other components other than the ‘modification means’ (2009) are the same as those described in the fifth to seventh embodiments, so that descriptions are omitted.

The ‘setting means for cutoff of video signal’ (2009) carries out setting as to whether the view processing of video signal is suspended regardless of the detection of plugging-in. The term ‘regardless of the detection of plugging-in’ means execution regardless of detection of plugging-in to the input terminal for mobile audio. Therefore, when viewing a normal TV program, the setting means for cutoff of video signal carries out setting as to whether the video muting is carried out. In cases where suspending of the view processing of video signal is set, for example, the video muting is carried out by a processing circuit for video output of the AV apparatus, and a masking-processed video is displayed on the display screen, or the backlight is switched off. This setting means for cutoff of video signal is provided with a normal TV as an accessory function.

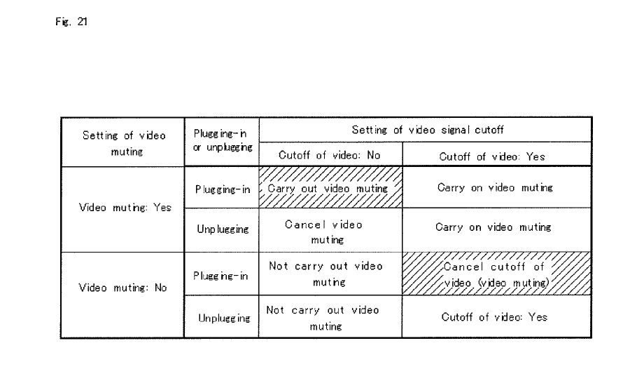

The ‘setting means for video muting on priority basis’ (2010) nullifies the setting of the setting means for cutoff of video signal in cases where there are conflicts between the setting of the video muting means and the setting of the setting means for cutoff of video signal. FIG. 21 shows the setting of setting means for video muting and the setting of setting means for video muting on priority basis. In FIG. 21, the shaded portion indicates the case, in which there are conflicts between the setting of the video muting means and the setting of the setting means for cutoff of video signal. Since the setting of the video muting means relates to a setting of the video muting in the case of detection of plugging-in, the conflicts occur only in the case of plugging-in, not in the case of unplugging. Hereinafter, a concrete description will be made. In a case of the conflicts, the setting of the ‘setting means for video muting’ is ‘video muting: yes’ (the view processing of video signal is suspended in cases where the plugging-in has been detected), and the setting of the ‘setting means for cutoff of video signal’ is ‘cutoff of video: no’ (the view processing of video signal is not suspended). In this case, before the plugging-in to the input terminal for mobile audio, the video is displayed. Here, in the case of the plugging-in to the input terminal for mobile audio, the processing of the video signal is carried out according to the setting of the setting means for video muting, ‘video muting: yes’ on a priority basis, thereby nullifying the setting of the setting means for cutoff of video signal. Consequently, in the case of plugging-in, the video muting is carried out based on the setting of the setting means for video muting regardless of the setting of the setting means for cutoff of video signal, ‘cutoff of video: no’.

In another case of the conflicts, the setting of the ‘setting means for video muting’ is ‘video muting: no’, and the setting of the ‘setting means for cutoff of video signal’ is ‘cutoff of video: yes’. In this case, before the plugging-in to the input terminal for mobile audio, the cutoff of video, therefore, video muting is carried out based on the setting of the setting means for cutoff of video signal, thereby nothing is displayed on the screen. Here, in the case of the plugging-in to the input terminal for mobile audio, the processing of the video signal is carried out according to the setting of the setting means for video muting, ‘video muting: no’ on a priority basis, thereby nullifying the setting of the setting means for cutoff of video signal. Consequently, in the case of plugging-in, the view processing of video signal is carried out based on the setting of the setting means for video muting regardless of the setting of the setting means for cutoff of video signal.

Further, the term ‘nullifies the setting of the setting means for cutoff of video signal’ means that, for example, on a management memory for managing the setting information of the setting means for cutoff of video signal, the setting information is temporarily rewritten to the information indicating that there is no setting of the setting means for cutoff of video signal. By this process, when the CPU of the processing unit reads respective setting information, it determines that there is no setting of the setting means for cutoff of video signal, and carries out subsequent processes, so that, consequently, the setting of the setting means for video muting is utilized on a priority basis. Thus, the setting of the setting means for cutoff of video signal is nullified in cases where there are conflicts between the setting of the video muting means and the setting of the setting means for cutoff of video signal, so that, for the user who listens to the mobile audio, all the user need to do is change the setting of the setting means for mobile audio, thereby improving usability for the user who listens to music etc. stored in the mobile audio by means of the AV apparatus.

### <Processing Flow of Eighth Embodiment>

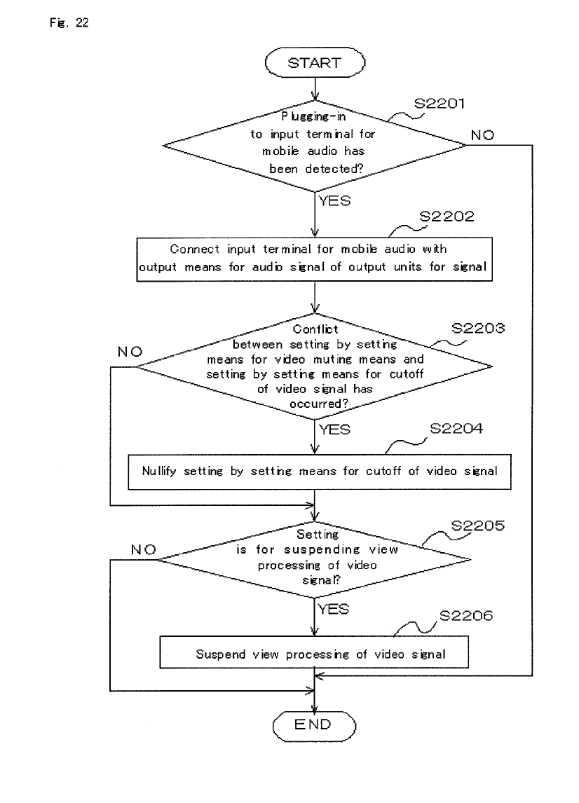

FIG. 22 is a flowchart of the eighth embodiment. The processes up to step S2202 are the same as those in any one of the fifth to seventh embodiments, so that descriptions are omitted. In step S2203, it is determined whether there are conflicts between the setting of the video muting means and the setting of the setting means for cutoff of video signal. In cases where it is determined in step S2203 that there are conflicts, the setting of the setting means for cutoff of video signal is nullified (step S2204). The subsequent steps are the same as the above-mentioned steps, so that descriptions are omitted. Note that, in FIG. 22, processing in the case of unplugging is omitted. The reason for this is that there are no conflicts between the setting of the video muting means and the setting of the setting means for cutoff of video signal in the case of the unplugging.

### <Brief Description of Effects of Eighth Embodiment>

The AV apparatus of the eighth embodiment comprises a setting means for cutoff of video signal, which carries out setting as to whether the view processing of video signal is suspended regardless of the detection of plugging-in, and nullifies the setting of the setting means for cutoff of video signal in cases where there are conflicts between the setting of the video muting means and the setting of the setting means for cutoff of video signal, thereby utilizing the setting of the video muting means on a priority basis. Accordingly, when listening to music from the mobile audio, the setting as to whether the video is displayed on the screen is carried out only by changing the setting of the setting means for video muting, thereby improving usability for the user.

### Ninth Embodiment

### <Concept of Ninth Embodiment>

The ninth embodiment is an AV apparatus, which can output the audio signal inputted from the input terminal for mobile audio without instantaneous interruption upon switching of channel of TV etc. in cases where the setting indicates that display of the video is continued in the case of plugging-in to the input terminal for mobile audio.

### <Configuration of Ninth Embodiment>

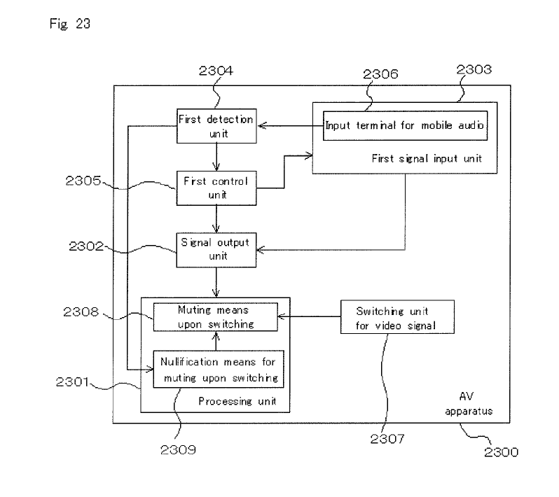

FIG. 23 is a functional block diagram of the ninth embodiment. In FIG. 23, an ‘AV apparatus’ (2300) of the ninth embodiment comprises a ‘processing unit’ (2301), a ‘signal output unit’ (2302), a ‘first signal input unit’ (2303), a ‘first detection unit’ (2304), a ‘first control unit’ (2305), and a ‘switching unit for video signal’ (2307). The ‘processing unit’ (2301) comprises ‘muting means upon switching’ (2308), and ‘nullification means for muting upon switching’ (2309).

In the ninth embodiment, the AV apparatus described in any one of the first to eighth embodiments further comprises the ‘switching unit for video signal’ (2307), the ‘muting means upon switching’ (2308), and the ‘nullification means for muting upon switching’ (2309). Components other than the ‘switching unit for video signal’ (2307), the ‘muting means upon switching’ (2308), and the ‘nullification means for muting upon switching’ (2309) are the same as those described in any one of the first to eighth embodiments, so that descriptions are omitted.

The ‘switching unit for video signal’ (2307) is for switching video signal of video, which is currently viewed, to other video signal. The term ‘video signal of video, which is currently viewed’ means a video signal, which is currently displayed and is viewed by a user. For example, the term ‘switching video signal of video to other video signal’ includes the case of switching video signal of video to other video signal by changing channel of TV program, which the user is currently viewing, or the case of switching to the video signal inputted from an external equipment such as a DVD device.

The ‘muting means upon switching’ (2308) carries out muting of audio signal upon switching in cases where the switching unit for video signal carries out switching. The term ‘muting of audio signal’ means the processing not to output the audio signal temporarily. For example, the audio output is not carried out instantaneously in order to prevent output of noise of the switching of channel upon changing of channels, thereby preventing sense of discomfort of the user.

The ‘nullification means for muting upon switching’ (2309) nullifies the function of the muting means upon switching so as not to carry out the muting of the audio signal regardless of the switching in cases where the plugging-in has been detected. The term ‘the plugging-in has been detected’ means the detection of the plugging-in to the input terminal for mobile audio. The term ‘nullifies the function of the muting means’ means that the function of muting the audio signal is nullified upon switching the video signal of video, currently being viewed, to other video signal. In cases where the plugging-in has been detected in the first detection unit, the inputted signal from the mobile audio is processed as the audio signal outputted from the AV apparatus as described above. Therefore, since switching of channels of the AV apparatus such as a TV does not have an affect on the inputted audio signal or the outputted audio signal, it is possible to listen to music from the mobile audio without interruption by nullifying a function of the muting means upon switching, even if the channel of TV is changed. Note that, in the ninth embodiment, the nullification of the function of the muting means upon switching may be carried out only in cases where the video muting is not set by the above-mentioned setting means for video muting, or the nullification of the function of the muting means upon switching may be carried out regardless of the setting of the setting means for video muting.

### <Processing Flow of Ninth Embodiment>

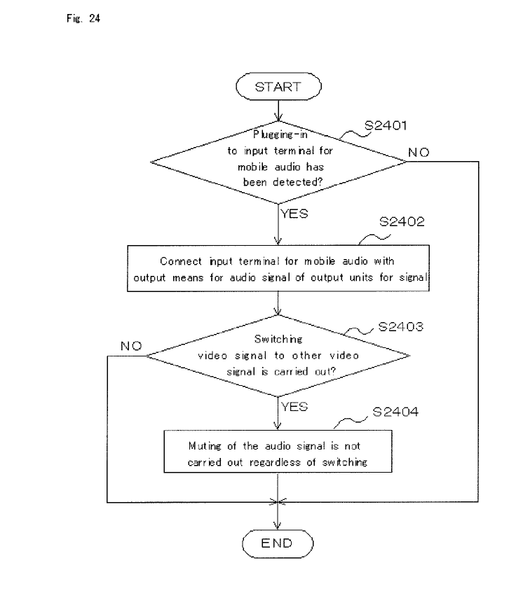

FIG. 24 is a flowchart of the ninth embodiment. The processes up to step S2402 are the same as those in any one of the first to eighth embodiments, so that descriptions are omitted. In step S2403, it is determined whether there has been a switching of video signal of video to other video signal. In cases where it is determined in step S2403 that there has been a switching, the processing flows to step S2404, and the muting of the audio signal is not carried out regardless of the switching. The subsequent processes are the same as those described in any one of the first to eighth embodiments.

### <Brief Description of Effects of Ninth Embodiment>

According to the AV apparatus of the ninth embodiment, even if there is a switching of video signal currently being viewed, the muting of audio signal is not carried out in the case of plugging-in to the input terminal for mobile audio, so that the AV apparatus can output the music etc. inputted from the mobile audio without interruption. Therefore, the user can change channels without sense of discomfort, thereby improving usability.

### Tenth Embodiment

### <Concept of Tenth Embodiment>

In the tenth embodiment, the AV apparatus stores a plurality of video information, and in the case of plugging-in to the input terminal for mobile audio, carries out video display based on the stored video information. Therefore, a user can view an original music video by storing the video information matching to the music from the mobile audio.

### <Configuration of Tenth Embodiment>

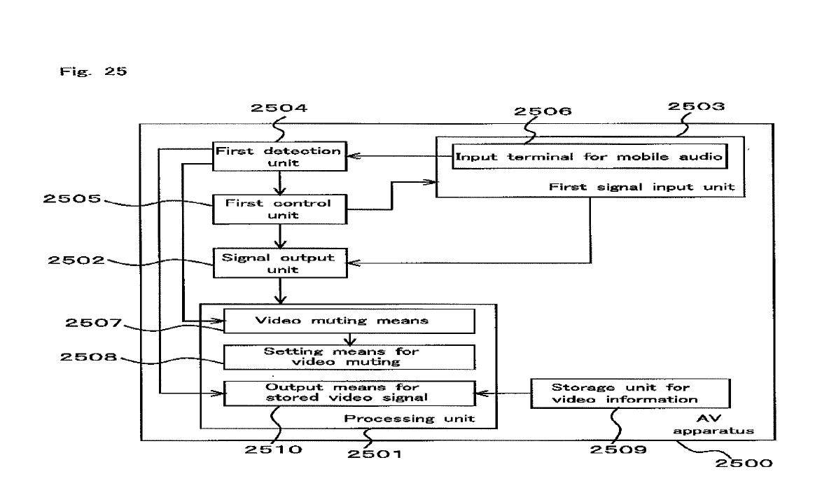

FIG. 25 is a functional block diagram of the ninth embodiment. In FIG. 25, an ‘AV apparatus’ (2500) of the ninth embodiment comprises a ‘processing unit’ (2501), a ‘signal output unit’ (2502), a ‘first signal input unit’ (2503), a ‘first detection unit’ (2504), a ‘first control unit’ (2505), and a ‘storage unit for video information’ (2509). The ‘processing unit’ (2501) comprises ‘setting means for video muting’ (2507), a ‘setting means for video muting (2508), and a ‘output means for stored video signal’ (2510).

In the ninth embodiment, the AV apparatus described in any one of the fifth to ninth embodiments further comprises the ‘storage unit for video information’ (2509), and the ‘output means for stored video signal’ (2510). Components other than the ‘storage unit for video information’ (2509), and the ‘output means for stored video signal’ (2510) are the same as those described in any one of the fifth to ninth embodiments, so that descriptions are omitted.

The ‘storage unit for video information’ (2509) stores a plurality of video information. The term ‘video information’ is information regarding the video signal outputted from the AV apparatus. The video information may be the video signal itself, or may be information regarding coded video. Examples of the video stored in the storage unit for video information include recorded TV program, a video shot by a user using a digital video camera, or a image such as a screen saver. In addition, the storage unit for video information may be configured to carry out addition, deletion, and variation etc. of the video information. Specifically, the storage unit for video information is configured by a storage medium such as a hard disk, or by an external storage medium such as a flash memory.

The ‘output means for stored video signal’ (2510) carries out the view processing of video signal by means of any one of the video information stored in the storage unit for video information in cases where the plugging-in has been detected in the first detection unit, and the setting of the setting means for video muting indicates that the view processing of video signal is not suspended. Therefore, in cases where the setting of the setting means for video muting indicates that the view processing of video signal is not suspended, and the plugging-in to the input terminal for mobile audio has been detected, the view processing of video signal by means of any one of the stored video information. Thus, it is possible to view the stored video according to the plugging-in to the input terminal for mobile audio, so that the user can enjoy viewing an original music video by viewing a predetermined video and by listening to the music from the mobile audio.

Although, in the tenth embodiment, it has been described that the processing unit (2501) carries out view processing of video signal by means of any one of the video information stored in the storage unit for video, it is possible to implement the same effect, for example, by the first control unit (2505). Therefore, the first control unit carries out control of connection between the signal input unit for the video signal stored in the video storage unit and the signal output unit, so that it is possible to output signal of the video information stored in the video storage unit to the processing unit for the view processing of video signal, and to view the video stored in the video storage unit. In addition, the setting as to whether the video stored in the video storage unit is displayed on the screen may be carried out in the case of plugging-in.

### <Processing Flow of Tenth Embodiment>

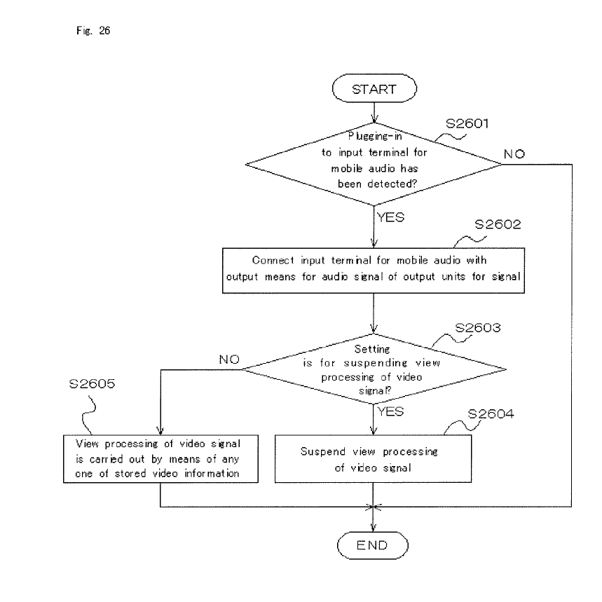

FIG. 26 is a flowchart of the tenth embodiment. The processes up to step S2602 are the same as those in any one of the fifth to ninth embodiments, so that descriptions are omitted. In step S2603, it is determined whether the setting indicates that the view processing of the video signal is suspended. In cases where it is determined in step S2603 that the setting indicates that the view processing of the video signal is not suspended, the processing flows to step S2605, and the view processing of video signal is carried out by means of any one of the stored video information. The subsequent processes are the same as those described above.

### <Brief Description of Effects of Tenth Embodiment>

According to the tenth embodiment, the AV apparatus stores a plurality of video information, and in the case of plugging-in to the input terminal for mobile audio, carries out video display based on the stored video information. Therefore, a user can view the stored video listening to the music from the mobile audio, thereby enjoying an original music video.

### Eleventh Embodiment

### <Concept of Eleventh Embodiment>

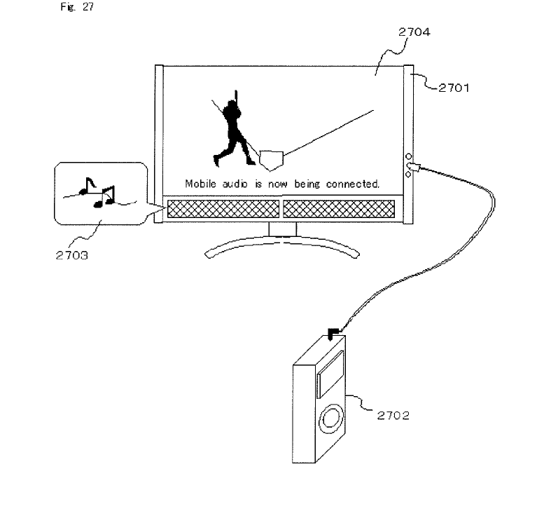

FIG. 27 is a conceptual diagram of an eleventh embodiment. In FIG. 27, an external electronic equipment (a mobile audio apparatus 2702) is connected with an AV apparatus (a television receiver 2701), thereby the audio signal from the external electronic equipment is processed as sound output of the AV apparatus. In this case, the video and the sound of the television receiver do not match each other. In FIG. 1, a live broadcast of a baseball game is displayed the screen (2704), and music from the mobile audio is played as the sound (2703). The AV apparatus of the eleventh embodiment detects the plugging-in from the external electronic equipment, and notifies that the output from a speaker is audio signal inputted from the external electronic equipment, for example, by an indication as ‘mobile audio is now being connected’ on a screen (a second video display unit). In addition, even in cases where the connection between the external electronic equipment and the AV apparatus is canceled, the AV apparatus of the eleventh embodiment carries out notification. In addition, even in cases where the play of the music ends, and no audio signal is inputted to the AV apparatus for a predetermined period of time, the AV apparatus of the eleventh embodiment carries out notification.

### <Configuration of Eleventh Embodiment>

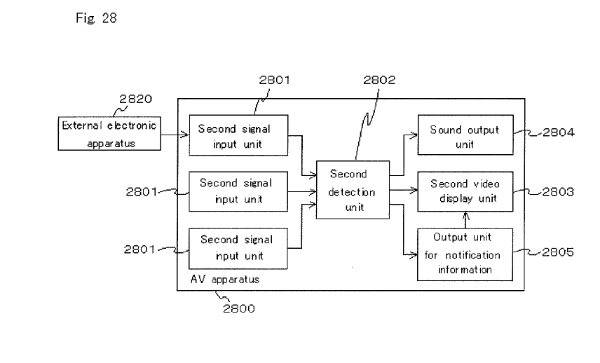

FIG. 28 is a functional block diagram of the eleventh embodiment. In FIG. 28, an ‘AV apparatus’ (2800) of the eleventh embodiment comprises a ‘second signal input unit’ (2801), a ‘second detection unit’ (2802), a ‘second video display unit’ (2803), a ‘sound output unit’ (2804), and an ‘output unit for notification information’ (2805).

Note that, any apparatus, which can output an audio signal and comprises a display unit capable of displaying a video etc. can be used as the ‘AV apparatus’ (2800). Examples of the AV apparatus include an audio player, a television receiver, a personal computer, and a car audio.

The ‘second signal input unit’ (2801) is configured to receive input of an audio signal from an external electronic equipment through a plug. The term ‘audio signal’ means information regarding voltage and frequency for determining tone and volume of the sound recorded in the built-in memory of the external electronic equipment. The audio signal may be either an analog signal or a digital signal. The ‘external electronic equipment’ (2820) is equipment capable of transmitting/receiving a signal with the AV apparatus, and in this specification, it is equipment, which is at least capable of transmitting the audio signal, and may be capable of displaying a video. Examples of the equipment include a portable audio apparatus such as a CD player or a MD player, a digital mobile audio apparatus or a DVD player, which includes a memory card, a non-volatile memory, and a compact hard-disk, and is capable of recording and reproducing sound such as music. The AV apparatus is connected by a cable via the external electronic equipment and the second signal input unit. As for the cable connection, an audio cable, an optical cable, and a USB cable can be utilized. In this case, as an output terminal of the external electronic equipment, any terminal capable of outputting an audio signal, for example, a headphone terminal, a line-out terminal, or a USB terminal may be utilized.

The ‘second detection unit’ (2802) is configured to detect plugging-in/unplugging at the second signal input unit (2801). It is determined whether there is the external connection by detecting the plugging-in/unplugging at the second signal input unit. The ‘plug’ corresponds to a plug, an end portion of a cable etc. to be connected to a headphone terminal or to a line-out terminal of the mobile audio. Examples of the plugging-include audio plugs of 3.5 mm and 5.5 mm, and specifically, the audio plug of 3.5 mm is preferable. The AV apparatus such as a TV becomes thinner, and the audio plug of 3.5 mm is used in many cases. The term ‘detects plugging-in/unplugging means detection of plugging-in or unplugging. Specifically, the first detection unit collects predetermined signals from respective terminals periodically or constantly. When a plug is plugged-in, a terminal becomes LOW state, indicating physical connection, and when the plug is unplugging, it becomes HIGH state, indicating disconnection, so that resistance value varies and the collected signal changes, thereby detecting plugging-in/unplugging. The detection unit can determine whether there is an external connection by detecting the plugging-in not only in the case of plugging-in/unplugging but also in the case where the AV apparatus is powered-on in the plugging-in state. The second detection unit can determine whether there is an external connection by detecting the plugging-in not only in the case of plugging-in/unplugging but also in the case where the AV apparatus is powered-on in the plugged-in state.

The ‘second video display unit’ (2803) is configured to display video content information. The term ‘video content information’ is information regarding a video included in a TV program or in a DVD. Further, the second video display unit is further configured to display the notification information from the output unit for notification information (2805), and this function will be described hereinafter. The signal of the TV program or in the DVD is divided into a signal regarding video and a signal regarding sound, and the signal regarding video is outputted by the second video display unit, and the signal regarding sound is outputted by the after-mentioned sound output unit (2804).

The ‘sound output unit’ (2804) is configured to output sound based on the audio signal of the video content information, or on the audio signal inputted from the second signal input unit (2801). The term ‘audio signal of the video content information’ is a signal regarding sound included in the TV program or in the DVD. The term ‘the audio signal inputted from the second signal input unit’ is an audio signal outputted from the external electronic equipment connected with the second signal input unit. The audio signal may be an inputted signal without variation, or may be a signal processed by an amplifier or by an attenuator in the AV apparatus. The sound output unit outputs the audio signal to the sound output device such as a speaker or a headphone.

The ‘output unit for notification information’ (2805) is configured to output notification information in order to carry out notification to a user to the second video display unit (2803) based on the detection result by the second detection unit (2802). In addition, the output unit for notification information may be configured to output the notification information in cases where the plugging-in has been detected in the second detection unit, and there is no audio signal inputted from a plug, plugged-in to the second signal input unit, for a predetermined period of time. The term ‘notification information’ is information for notification regarding the external electronic equipment to a user. The output unit for notification information stores the notification information corresponding to the detection result, so that it receives the detection result from the second detection unit, searches the stored notification information, and outputs the notification information corresponding to the detection result. In cases where there has been a plugging-in to the second signal input unit, and the plugging-in has been detected in the second detection unit, the connection with the external electronic equipment is outputted to the second video display unit, thereby carrying out a notification to a user. For example, as shown in FIG. 27, the indication of ‘mobile audio is now being connected’ is displayed. The output of the notification information may be carried out for a predetermined period of time after the plugging-in, or may be carried out throughout the connection. For example, a large indication may be displayed on the central portion of the second video display unit for 5 seconds from the detection of the plugging-in, and after that, a small indication may be displayed on the corner of the second video display unit. Meanwhile, in cases where there has been an unplugging from the second signal input unit, and the unplugging has been detected in the second detection unit, the cancellation of the connection with the external electronic equipment is outputted to the second video display unit, thereby carrying out a notification to a user. For example, the indication as ‘connection from the mobile audio was canceled’ is displayed for a predetermined period of time after the unplugging.

In addition, in cases where there has been a plugging-in to the second signal input unit (2801), the plugging-in has been detected in the second detection unit (2802), and there is no audio signal inputted from the external electronic equipment for a predetermined period of time, the connection with the external electronic equipment is re-outputted to the second video display unit, thereby carrying out a notification to a user. As the case of the notification, the case where the user forgets the connection with the external electronic equipment is cited. The output unit for notification information includes a timer for measurement of lapse of time, and stores information for determining no-signal for a predetermined period of time. The lapse of time from the point, at which no-signal from the external electronic equipment has started, is measured, and if the predetermined period of time of no-signal lapses, the notification information is outputted. The predetermined period of time of no-signal may be stored by the AV apparatus as a default value, or may be set by the user. In addition, a function of breaking a circuit for detecting the plugging-in/unplugging in the second detection unit, in cases where no process is carried out after the notification, may be provided, thereby reducing unnecessary energy consumption.

### <Processing Flow of Eleventh Embodiment>

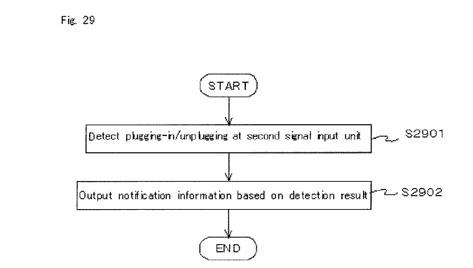

FIG. 29 is a flowchart of the eleventh embodiment. At the outset, detection of plugging-in/unplugging at the second signal input unit is carried out (second detecting step S2901). Subsequently, the notification information in order to carry out notification to a user is outputted based on the detection result by the second detection step (outputting step for notification information S2902).

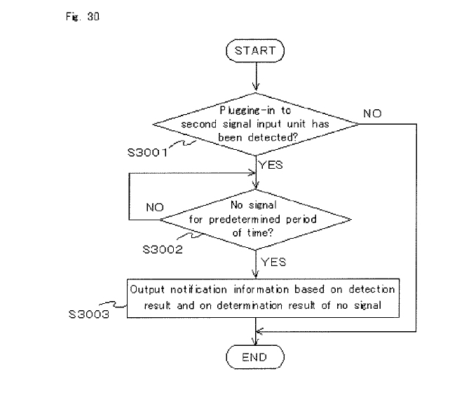

FIG. 30 is another flowchart of the eleventh embodiment. At the outset, detection of plugging-in/unplugging at the second signal input unit is carried out (second detecting step S3001). In cases where the detection result by the second detecting step indicates that there has been a plugging-in (S3001 YES), it is determined whether there is no audio signal inputted to the second signal input unit for a predetermined period of time (determining step for no-signal S3002). Subsequently, in cases where it is determined that there is no signal for a predetermined period of time (S3002 YES), the notification information is outputted based on the detection result by the second detecting step and the determination result by the determining step for no-signal (outputting step for notification information S3003).

### <Brief Description of Effects of Eleventh Embodiment>

The AV apparatus of the eleventh embodiment can detect a connection status between the external electronic equipment and the AV apparatus, determine no-signal, and carry out notification to the user based on the detection result or the determination result. Therefore, the user can easily know the connection status of the external electronic equipment, thereby improving usability when listening to music etc.

### Twelfth Embodiment

### <Concept of Twelfth Embodiment>

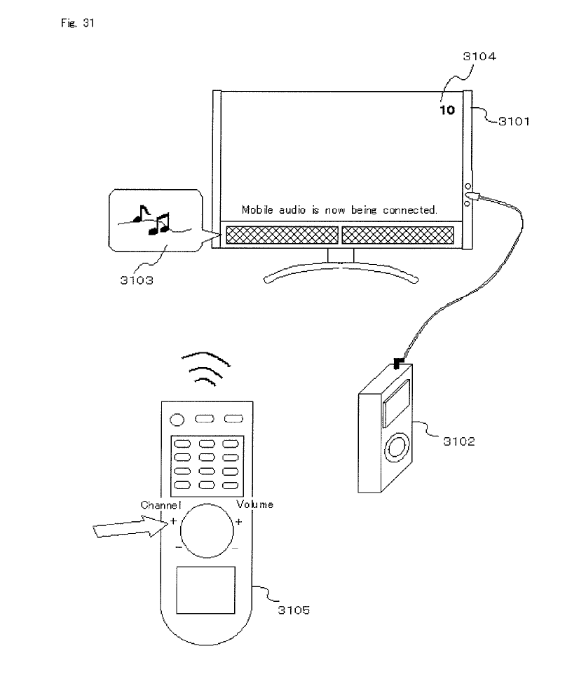

FIG. 31 is a conceptual diagram of a twelfth embodiment. In FIG. 31, an AV apparatus (a television receiver 3101) is set so as to carry out the muting control of the second video display unit during connection with an external electronic equipment (a mobile audio apparatus 3102), so that nothing is displayed on the screen (3104), and music (3103) inputted from the external electronic equipment is outputted. Here, if the user presses a channel selection button of the remote control (3105) of the AV apparatus, since both video and sound of the TV program are not outputted to the screen, nothing is displayed even if the channel selection is carried out, the user may misunderstand that it is a failure and feel anxiety. In order to carry out notification to the user, the notification information as ‘mobile audio is now being connected’ is outputted to and displayed on the second video display unit. In this case, lighting-up of a fluorescent tube or a LED block for the portion, on which the notification information as ‘mobile audio is now being connected’ is displayed, may be carried out.

### <Configuration of Twelfth Embodiment>

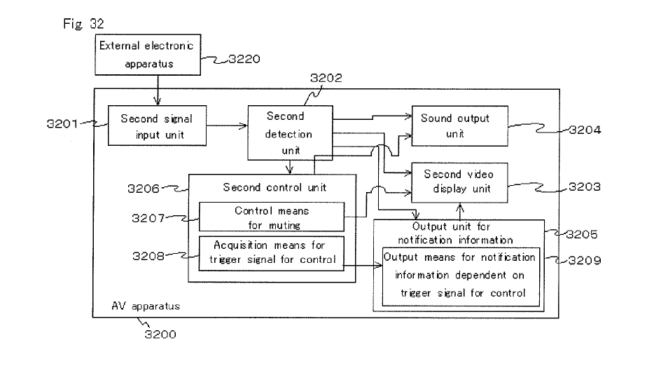

FIG. 32 is a functional block diagram of the twelfth embodiment. In FIG. 32, an ‘AV apparatus’ (3200) of the twelfth embodiment is based on the eleventh embodiment, and comprises a ‘second signal input unit’ (3201), a ‘second detection unit’ (3202), a ‘second video display unit’ (3203), a ‘sound output unit’ (3204), an ‘output unit for notification information’ (3205), and ‘second control unit’ (3206). The second control unit further comprises ‘control means for muting’ (3207), and ‘acquisition means for trigger signal for control’ (3208). The output unit for notification information further comprises ‘output means for notification information dependent on trigger signal for control’ (3209).

The ‘second control unit’ (3206) is configured to control respective units. In addition, it comprises the after-mentioned ‘control means for muting’ (3207) and ‘acquisition means for trigger signal for control’ (3208).

The ‘control means for muting’ (3207) is configured to be capable of controlling muting of display in the second video display unit (3203) in cases where the plugging-in has been detected in the second detection unit (3202). The ‘muting control’ is not to carry out outputting a signal. In cases where the audio signal inputted from the second signal input unit (3201) of the AV apparatus is outputted, there is a case where only the output of the audio signal is necessary, and depending on a user, video display is unnecessary. The outputting of unnecessary video display is unnecessary consumption of electricity. Therefore, the second control unit comprises the muting control means. For example, in FIG. 27, the live broadcast of a baseball game is displayed on the screen, meanwhile, in the twelfth embodiment, it is possible to output nothing by the muting control and to make the screen completely black. Therefore, only music inputted from the mobile audio is played. In the muting control, not only the above-mentioned completely black screen but also a screen of other simple color such as a blue screen may be displayed, or a screen saver etc. may be displayed. In addition, the muting control not only for the entire portion but also for a portion of the second video display unit may be carried out. For example, a control window comprising a menu button for adjustment of sound/volume may be displayed on the corner of the second video display unit, and the muting control of the other portions may be carried out. The setting as to whether the muting control is carried out can be preliminarily done by the user through an operation of a menu or of a button of the AV apparatus. In addition, the reason for the term ‘in cases where the plugging-in has been detected in the second detection unit’ is that if the detection result indicates that there has been no plugging-in, the external electronic equipment is not connected, and the muting control depends on the function, originally provided with the AV apparatus.

The ‘acquisition means for trigger signal for control’ (3208) is configured to acquire a trigger signal for control in order to control each unit, in which the second control unit has a function of controlling the above units. The ‘trigger signal for control’ is a signal for controlling respective units of the AV apparatus, and for example, is a signal for various functions of the AV apparatus such as power-on, volume up, selecting broadcast channels, recording, and extracting a CD. The trigger signal for control may be acquired by any method. For example, the user can select a function, or the AV apparatus can automatically carry out the acquisition according to a setting of a timer. Further, the acquisition may be carried out according to a signal via a communication by means of a remote control etc.

The ‘output means for notification information dependent on trigger signal for control’ (3209) is comprised by the output unit for notification information (3205) of the twelfth embodiment, and is configured to output the notification information based on a predetermined trigger signal for control acquired by the acquisition means for trigger signal for control (3208). The term ‘based on a trigger signal for control’ means an execution according to the acquisition of the trigger signal for control. In addition, the notification information may be outputted according to a type of the trigger signal for control. The type of the trigger signal for control means a type of signal such as a signal regarding volume, a signal regarding video recording, or a signal regarding timer. In cases where the trigger signal for control is not operable during the mobile audio is connected, the notification of inoperability can be done, and in cases where the trigger signal for control is operable, the notification to the effect that the signal is being processed can be carried out. For example, in cases where video recording of TV program is programmed by means of a timer, and start time of the recording comes while the mobile audio is connected, the output means for notification information dependent on trigger signal for control notifies the start of the recording based on the trigger signal for control in order to start recording to the second video display unit. In addition, as described in FIG. 31, in cases where the channel select of the TV program is carried out during the muting control, if there is no response to the user's operation, the user possibly misunderstands that as a failure. Therefore, an indication as ‘muting control is now being carried out’ is displayed.

### <Processing Flow of Twelfth Embodiment>

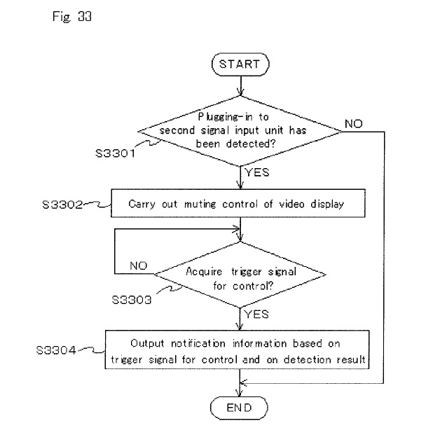

FIG. 33 is another flowchart of the twelfth embodiment. At the outset, detection of plugging-in/unplugging at the second signal input unit is carried out (second detecting step S3301). In cases where the detection result by the second detecting step indicates that there has been a plugging-in (S3301 YES), the muting control of the display in the second video display unit is carried out (muting control step S3302). Subsequently, the trigger signal for control in order to control respective units is acquired (acquiring step for trigger signal for control S3303 YES). Finally, the notification information is outputted based on the trigger signal for control acquired by the acquiring step for trigger signal for control and on the detection result by the second detecting step (outputting step for notification information dependent on trigger signal for control S3304).

### <Brief Description of Effects of Twelfth Embodiment>

The AV apparatus of the twelfth embodiment can output the notification information based on the trigger signal for control, so that even if an operation not indicated on the second video display unit is done, the user can confirm by the notification information, thereby improving operability while the external electronic equipment such as the mobile audio is connected.

### Thirteenth Embodiment

### <Concept of Thirteenth Embodiment>

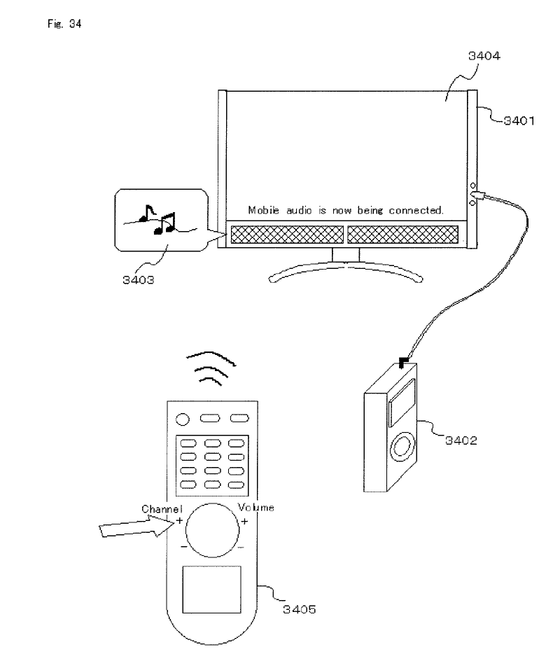

FIG. 34 is a conceptual diagram of a thirteenth embodiment. In FIG. 34, the AV apparatus (a television receiver 3401) is set so as to carry out the muting control of the second video display unit during connection with the external electronic equipment (a mobile audio apparatus 3402), so that nothing is displayed on the screen (3404), and music (3403) inputted from the external electronic equipment is outputted. Here, if the user presses a channel selection button of the remote control (3405) of the AV apparatus, since neither video nor sound of the TV program are outputted to the screen, the channel select is meaningless. In order to prevent the meaningless operation, the AV apparatus of the thirteenth embodiment nullifies the trigger signal for control, other than a trigger signal for control regarding power or volume/sound, and in order to carry out notification to the user, the notification information as ‘mobile audio is now being connected’ is outputted to and displayed on the second video display unit.

### <Configuration of Thirteenth Embodiment>

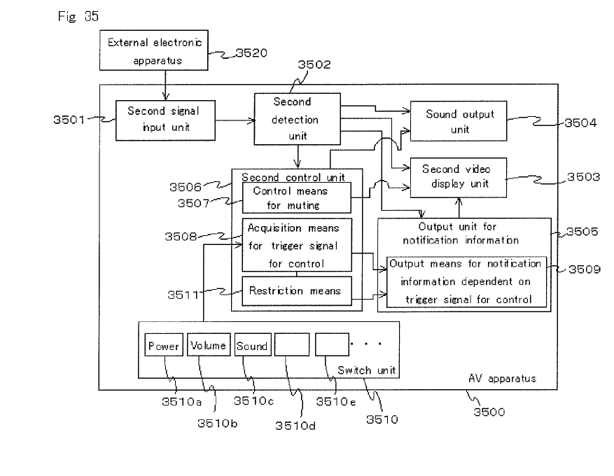

FIG. 35 is a functional block diagram of the thirteenth embodiment. In FIG. 35, an ‘AV apparatus’ (3500) of the thirteenth embodiment is based on the twelfth embodiment, and comprises a ‘second signal input unit’ (3501), a ‘second detection unit’ (3502), a ‘second video display unit’ (3503), a ‘sound output unit’ (3504), an ‘output unit for notification information’ (3505), and a ‘second control unit’ (3506). The second control unit further comprises ‘control means for muting’ (3507), and ‘acquisition means for trigger signal for control’ (3508). The output unit for notification information further comprises ‘output means for notification information dependent on trigger signal for control’ (3509). In addition, a ‘switch unit’ (3510) is further comprised, and the second control unit comprises a ‘restriction means’ (3511).

The ‘switch unit’ (3510) transmits the trigger signal for control of each unit to the second control unit (3506) in accordance with operation. The switch unit transmits the trigger signal for control of each unit to the second control unit (3506) according to operation such as pressing button of the AV apparatus or of the remote control, selecting enter button or moving a dial or a knob on a menu screen for setting. The switch unit transmits signals for various operations such as a signal regarding power (3510a), volume (3510b), or sound (3510c) etc. In the functional block diagram of FIG. 35, although the switch unit (3510) is installed inside the AV apparatus, the switch unit may be separated from the AV apparatus such as a remote control. In this case, the trigger signal for control is transmitted to the second control unit via infrared-ray and an infrared-ray receiver of the AV apparatus. In addition, not only a trigger signal for immediately carrying out control, a trigger signal for control in order to automatically start the control by means of a timer for program etc. may be transmitted.

The ‘restriction means’ (3511) nullifies the trigger signal for control, transmitted from the switch unit (3510), other than a trigger signal for control regarding power or volume/sound during the muting control by the control means for muting (3507). The reason for the term ‘during the muting control’ is that the video is not displayed on the second video display unit during the muting control, and it is both meaningless and inconvenient to carry out a function, which is originally provided with the AV apparatus, at the same time as sound output from the external electronic equipment. For example, as described above, functions such as channel selection of TV program and adjustment of image quality are meaningless. Therefore, in cases where trigger signals for control regarding such functions are received, the trigger signals for control are nullified, thereby not carrying out the processes. Meanwhile, since the function regarding power or volume/sound is necessary during sound output from the external electronic equipment, control of respective units are carried out according to the trigger signals for control. The trigger signal for control regarding ‘power (3510a)’ is a signal of power-on/off. The trigger signal for control regarding ‘volume (3510b)’ is a signal for volume-up/down, muting, and adjustment of sound balance etc. The restriction means nullifies the trigger signal for control, transmitted from the switch unit (3510d, 3510e, and so on), other than a trigger signal for control regarding power or volume/sound, and outputs information to not carry out processing of the trigger signal for control to the output unit for notification information.

The output unit for notification information (3505) of the thirteenth embodiment outputs the notification information based on the trigger signal for control nullified by the output means for notification information dependent on trigger signal for control’ (3509). The output unit for notification information stores notification information correlated with information regarding type of trigger signal for control, information regarding type of switch unit, or information regarding nullification. In the case of receiving the trigger signal for control, selection and output of the notification information correlated with the trigger signal for control are carried out. For example, in FIG. 34, in cases where the channel selection button is pressed, the notification information to display an indication such as ‘mobile audio is now being connected’ or ‘channel selection is not effective’ on the second video display unit is outputted. Here, color and size of letters displayed on the second video display unit may be changed according to type of the trigger signal for control.

### <Processing Flow of Thirteenth Embodiment>

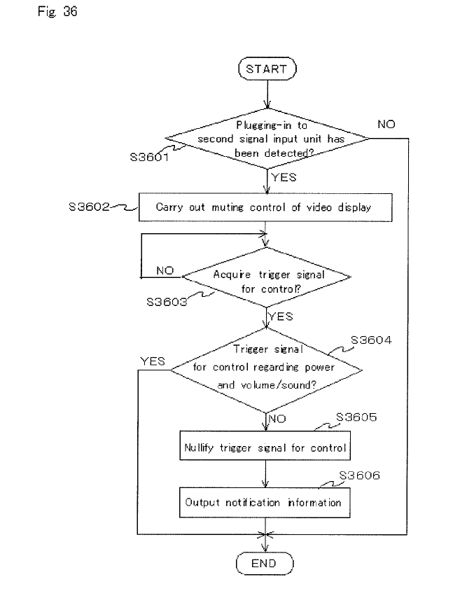

FIG. 36 is another flowchart of the thirteenth embodiment. At the outset, detection of plugging-in/unplugging at the second signal input unit is carried out (second detecting step S360 1). In cases where the detection result by the second detecting step indicates that there has been a plugging-in (S3601 YES), the muting control of the display in the second video display unit is carried out (muting control step S3602). Subsequently, the trigger signal for control in order to control respective units is acquired (acquiring step for trigger signal for control S3603 YES). It is determined whether the trigger signal for control acquired by the acquiring step for trigger signal for control is other than a trigger signal for control regarding power or volume/sound (determining step S3604). Subsequently, in cases where it is determined in the determining step that the trigger signal for control is other than a trigger signal for control regarding volume/sound (S3604 NO), the trigger signal for control is nullified restricting step S3605). Finally, in the case of carrying out nullification by the restricting step, the notification information is outputted (outputting step for notification information of nullified trigger signal for control S3606).

### <Brief Description of Effects of Thirteenth Embodiment>

The AV apparatus of the thirteenth embodiment nullifies the trigger signal for control in cases where the trigger signal for control is other than a trigger signal for control regarding power or volume/sound, thereby preventing meaningless operation and in order to carry out notification to the effect that the operation is nullified to the user.

### Fourteenth Embodiment

### <Concept of Fourteenth Embodiment>

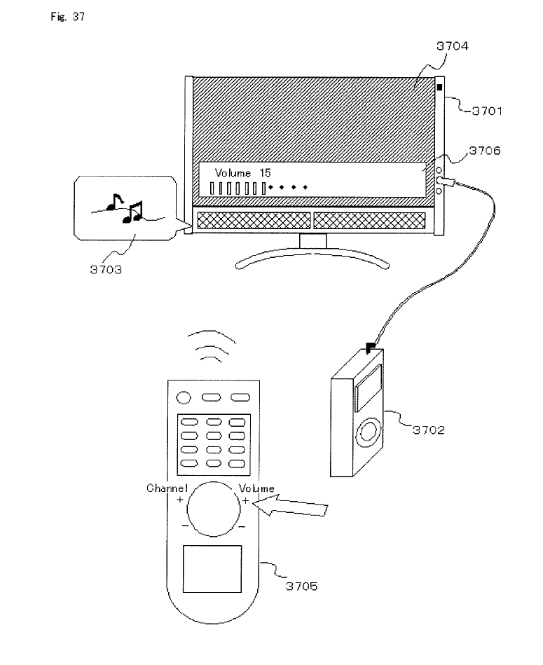

FIG. 37 is a conceptual diagram of a fourteenth embodiment. In FIG. 37, an AV apparatus (a television receiver 3701) is set so as to carry out the muting control during connection with the external electronic equipment (a mobile audio apparatus 3702), so that nothing is displayed on the screen (3704), and music (3703) inputted from the external electronic equipment is outputted. Here, the user presses a volume button of a remote control (3705) in order to increase volume. Although it is set to carry out the muting control during connection with the external electronic equipment, so that nothing is displayed on the screen (3704), in the case of volume setting, lighting up of a backlight (3706) of the screen is carried out, and volume level is indicated.

### <Configuration of Fourteenth Embodiment>

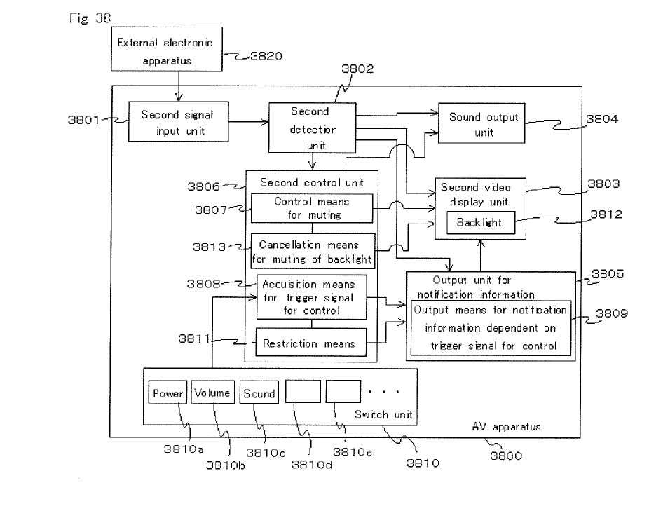

FIG. 38 is a functional block diagram of the fourteenth embodiment. In FIG. 38, an ‘AV apparatus’ (3800) of the fourteenth embodiment is based on the thirteenth embodiment, and comprises a ‘second signal input unit’ (3801), a ‘second detection unit’ (3802), a ‘second video display unit’ (3803), a ‘sound output unit’ (3804), an ‘output unit for notification information’ (3805), a ‘second control unit’ (3806), and a ‘switch unit’ (3810). The second control unit further comprises a ‘control means for muting’ (3807), ‘acquisition means for trigger signal for control’ (3808), and the second control unit comprises ‘restriction means’ (3811). The output unit for notification information comprises ‘output means for notification information dependent on trigger signal for control’ (3809). In addition, the second video display unit further comprises a ‘backlight’ (3812), and the second control unit further comprises ‘cancellation means for muting of backlight’ (3813).

The ‘backlight’ (3812) is a light for adjusting brightness of the second video display unit (3803). The control means for muting (3807) does not carry out video display, and switches off the backlight, thereby carrying out muting control. The number of backlights is not limited to one, and may be plural. In the case of comprising one backlight, it is possible only to carry out switching on/off. Meanwhile, in the case of comprising a plurality of backlights, or the case of LED backlight, it is possible to carry out switching on/off with respect to each fluorescent tube or each LED lighting block.

The ‘cancellation means for muting of backlight’ (3813) is configured to cancel all or part of muting control of the backlight (3812) in cases where the trigger signal for control, transmitted by the switch unit (3810), is the trigger signal for control regarding volume/sound during the muting control by the control means for muting. As described above, in cases where the trigger signal for control, transmitted by the switch unit (3810), is the trigger signal for control regarding power (3810a), or volume (3810b)/ sound (3810c), it is necessary to carry out processing even in the muting control. Additionally, there is a possibility of displaying necessary indication on the second video display unit. Therefore, all or part of muting control of the backlight of the second video display unit is canceled, thereby enabling necessary display for processing. For example, in cases where the user presses a volume button of a remote control as shown in FIG. 37, the volume level is displayed on the second video display unit so that it is possible to visually know the volume. The cancelled of part of muting control of the backlight is carried out by canceling the video muting of a portion for display, for example, the lower half of the second video display unit. Therefore, it is possible to reduce unnecessary energy consumption. After the termination of control of respective units, switching off of the backlight, and returning to the muting control state are carried out after a predetermined period of time.

### <Processing Flow of Fourteenth Embodiment>

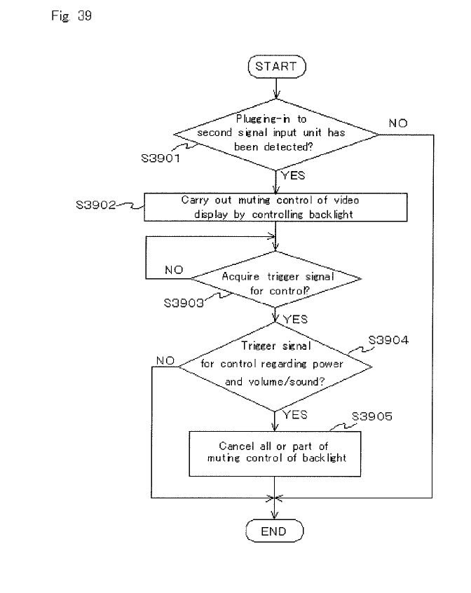

FIG. 39 is a flowchart of the fourteenth embodiment. At the outset, detection of plugging-in/unplugging at the second signal input unit is carried out (second detecting step S3901). In cases where the detection result by the second detecting step indicates that there has been a plugging-in (S3901 YES), the muting control of the backlight is carried out (canceling step for muting of backlight S3902). Subsequently, the trigger signal for control in order to control respective units is acquired acquiring step for trigger signal for control S3903 YES). It is determined whether the trigger signal for control acquired by the acquiring step for trigger signal for control is a trigger signal for control other than a trigger signal for control regarding power or volume/sound (determining step S3904). Subsequently, in cases where it is determined in the determining step that the trigger signal for control is a trigger signal for control regarding volume/sound (S3904 YES), cancellation of all or part of muting control of the backlight is carried out (canceling step for muting of backlight S3905).

### <Brief Description of Effects of Fourteenth Embodiment>

The AV apparatus of the fourteenth embodiment cancels all or part of muting control of the backlight even during the muting control in cases where the trigger signal for control regarding volume/sound is transmitted, thereby enabling a processing of power or volume/sound. Moreover, in cases where a part of muting control of the backlight is cancelled, it is possible to reduce unnecessary energy consumption.

### Fifteenth Embodiment

### <Concept of Fifteenth Embodiment>

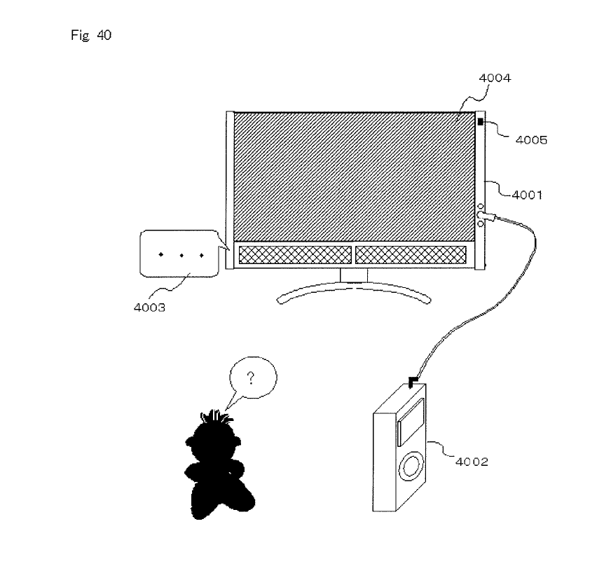

FIG. 40 is a conceptual diagram of a fifteenth embodiment. In FIG. 40, an AV apparatus (a television receiver 4001) is switched off while being connected with the external electronic equipment (a mobile audio apparatus 4002), and is set so as to carry out muting control while the external electronic equipment is connected. The user forgets that the external electronic equipment is connected, and switches on a power button (4005) of the television receiver. It is set to carry out the muting control while the mobile audio is connected, so that nothing is displayed on a screen (4004), and music from the external electronic equipment is not played, so that the sound is not outputted (4003). Therefore, there is a possibility that the user is bewildered. The AV apparatus of the fifteenth embodiment can notify that the external electronic equipment is connected.

### <Configuration of Fifteenth Embodiment>

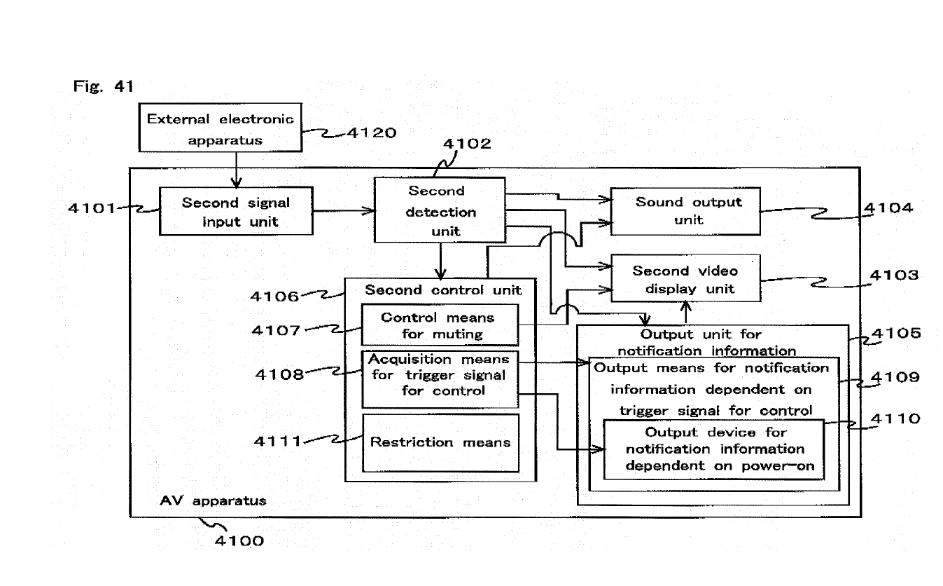

FIG. 41 is a functional block diagram of the fourteenth embodiment. In FIG. 41, an ‘AV apparatus’ (4100) of the fifteenth embodiment is based on the twelfth embodiment, and comprises a ‘second signal input unit’ (4101), a ‘second detection unit’ (4102), a ‘second video display unit’ (4103), a ‘sound output unit’ (4104), an ‘output unit for notification information’ (4105), and a ‘second control unit’(4106). The second control unit further comprises ‘control means for muting’ (4107), ‘acquisition means for trigger signal for control’ (4108), and the second control unit comprises ‘restriction means’ (4111). The output unit for notification information comprises ‘output means for notification information dependent on trigger signal for control’ (4109). In addition, the output means for notification information dependent on trigger signal for control further comprises an ‘output device for notification information dependent on power-on’ (4110). Note that, the fourteenth embodiment is based on the twelfth embodiment, and may be based on the thirteenth embodiment.

The ‘output device for notification information dependent on power-on’ (4110) displays notification information based on a power-on signal as a trigger signal for control. The fifteenth embodiment is based on the case where the AV apparatus in the power-off state is connected with the external electronic equipment, and the muting control is set to be carried out, or the case where the AV apparatus, connected with the external electronic equipment, is switched off, and the muting control is set to be carried out. In these cases, as described above, it is set to carry out the muting control while the mobile audio is connected, so that nothing is displayed on the screen, and the user is bewildered. In order to solve this, when acquiring the power-on signal, the second control unit outputs the signal to the output device for notification information dependent on power-on, and the output device for notification information dependent on power-on outputs information, indicating that the external electronic equipment is connected, to the second video display unit. For example, it is possible to display an indication as ‘mobile audio is now being connected’.

### <Processing Flow of Fifteenth Embodiment>

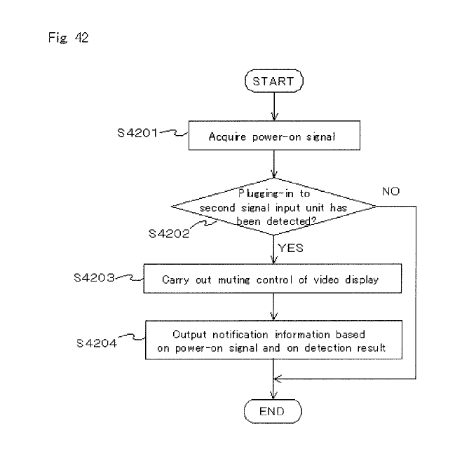

FIG. 42 is another flowchart of the fifteenth embodiment. At the outset, the power-on signal of the AV apparatus is acquired (acquiring step for power-on signal S4201). Subsequently, detection of plugging-in/unplugging at the second signal input unit is carried out (second detecting step S4202). In cases where the detection result by the second detecting step indicates that there has been a plugging-in(S4202 YES), the muting control of the display in the second video display unit is carried out (muting control step S4203). Finally, the notification information is outputted based on the power-on signal acquired by the acquiring step for power-on signal, and on the detection result by the second detecting step (outputting step for notification information dependent on power-on S4204).

### <Brief Description of Effects of Fifteenth Embodiment>

The AV apparatus of the fifteenth embodiment outputs the notification information in cases where the AV apparatus is switched on under the muting control, thereby solving the deficiency that the user is bewildered by the non-display state.

### Sixteenth Embodiment

### <Concept of Sixteenth Embodiment>

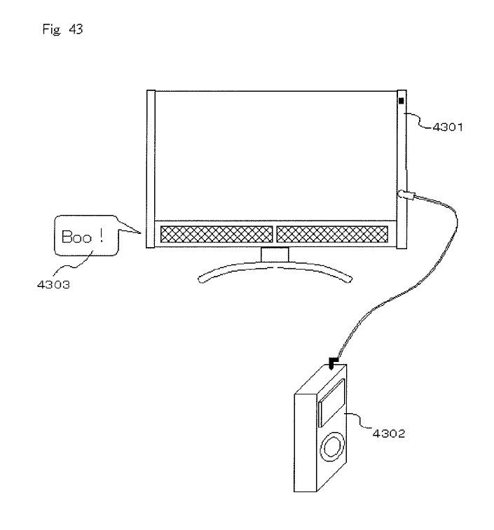

FIG. 43 is a conceptual diagram of a sixteenth embodiment. In FIG. 43, an AV apparatus (a television receiver 4301) can output notification sound (4303) in place of or in addition to the output of the notification information to the second video display unit as described in the eleventh to fifteenth embodiments. For example, as to the notification as described in the eleventh embodiment in cases where the user forgets that an external electronic equipment (4302) is connected, and there has been no signal for a predetermined period of time, the output of the notification sound is more effective than the indication on the second video display unit.

### <Configuration of Sixteenth Embodiment>

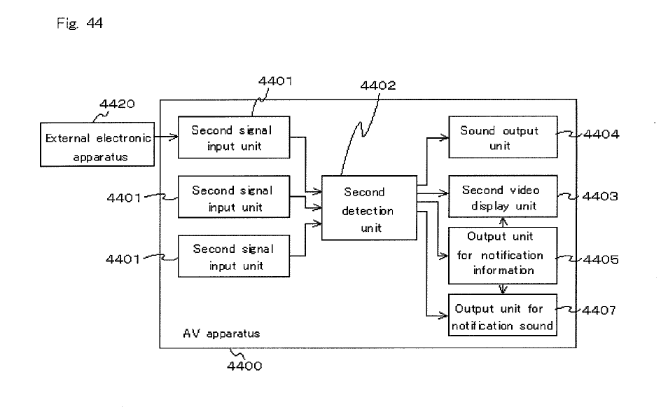

FIG. 44 is a functional block diagram of the fourteenth embodiment. In FIG. 44, an ‘AV apparatus’ (4400) of the fifteenth embodiment is based on the twelfth embodiment, and comprises a ‘second signal input unit’ (4401), a ‘second detection unit’ (4402), a ‘second video display unit’ (4403), a ‘sound output unit’ (4404), an ‘output unit for notification information’ (4405), and an ‘output unit for notification sound’ (4407). Note that, the fifteenth embodiment is based on the eleventh embodiment, and may be based on any one of the eleventh to fifteenth embodiments.

The ‘output unit for notification sound’ (4407) is configured to output notification sound. The ‘notification sound’ is a sound for notifying an existence of the notification information to the user. The notification sound is not limited to a simple tone, and may be a melody or a voice. In addition, the notification sound may be changed according to type of notification, and may be selected by the user. Moreover, an output time of the notification sound may be a predetermined period of time after acquisition of the notification information, and in cases where there has been no signal for a predetermined period of time, the notification sound may be outputted at a predetermined interval.

The output unit for notification information (4405) of the sixteenth embodiment has a function of outputting the notification information to the output unit for notification sound in place of or in addition to the function of outputting the notification information to the second video display unit (4403) as described in the eleventh to sixteenth embodiments. Since the purpose of the notification is unclear if the notification is carried out only by the notification sound, an indication on the second video display unit is carried out along with the notification sound, thereby making the notification more effective.

### <Brief Description of Effects of Sixteenth Embodiment>

The AV apparatus of the sixteenth embodiment has a function of outputting the notification information to the output unit for notification sound in place of or in addition to the function of outputting the notification information to the second video display unit, so that it is possible to carry out notification to the user not only visually but also aurally, and to carry out notification to aurally-challenged people.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. An AV apparatus, comprising:
a processing unit, which carries out view processing;
a signal output unit, which outputs a signal to the processing unit;
a plurality of first signal input units, which includes input terminal for mobile audio;
a first detection unit, which detects plugging-in/unplugging at said input terminal for mobile audio; and
a first control unit, which controls connection between said plurality of first signal input units and said signal output unit in accordance with a detection result by said first detection unit.

2. The AV apparatus according to claim 1, wherein said first control unit comprises
connection means for mobile audio on priority basis, which connects said input terminal for mobile audio with an output means for audio signal, which is for outputting an audio signal, in the signal output units in cases where the plugging-in has been detected in the first detection unit.

3. The AV apparatus according to claim 2, wherein
said processing unit comprises
video muting means, which suspends the view processing of video signal in cases where the plugging-in has been detected in the first detection unit.

4. The AV apparatus according to claim 3, further comprising:
a first video display unit including a backlight, wherein
said video muting means, comprises
an energy-saving device, which switches off the backlight upon suspending the view processing of video signal.

5. The AV apparatus according to claim 3, further comprising:
a first video display unit including a backlight, wherein
said video muting means, comprises
a reduction device for brightness, which reduces brightness of the backlight upon suspending the view processing of video signal.

6. The AV apparatus according to claim 5, wherein
said processing unit, comprises
setting means for video muting, which carries out setting as to whether the view processing of video signal is suspended in said video muting means.

7. The AV apparatus according to claim 3, wherein
said processing unit comprises
video resuming means, which resumes the view processing of video signal in cases where the unplugging has been detected in the first detection unit.

8. The AV apparatus according to claim 7, further comprising:
modification means, which modifies said video signal in cases where said video muting means suspends the view processing of video signal, and/or in cases where said video resuming means resumes the view processing of video signal.

9. The AV apparatus according to claim 6, wherein
said processing unit comprises
setting means for cutoff of video signal, which carries out setting as to whether the view processing of video signal is suspended regardless of said detection of plugging-in, and
setting means for video muting on priority basis, which nullifies the setting of said setting means for cutoff of video signal in cases where there is conflicts between the setting of said video muting means and the setting of said setting means for cutoff of video signal.

10. The AV apparatus according claim 9, further comprising:
a switching unit for video signal, which is for switching video signal of video, currently being viewed, to other video signal, wherein
said processing unit, comprises
muting means upon switching, which carries out muting of audio signal upon switching in cases where said switching unit for video signal carries out switching, and
nullification means for muting upon switching, which nullifies the function of the muting means upon switching so as not to carry out the muting of the audio signal regardless of the switching in cases where said the plugging-in has been detected.

11. The AV apparatus according to claim 9, further comprising:
a storage unit for video information, which stores a plurality of video information, wherein
said processing unit, comprises
output means for stored video signal, which carries out the view processing of video signal by means of any one of the video information stored in said storage unit for video information in cases where the plugging-in has been detected in the first detection unit, and the setting of said setting means for video muting indicates that the view processing of video signal is not suspended.

12. An operation method for AV apparatus, comprising:
a first signal output unit, which outputs a signal, and
a plurality of first signal input units, which includes input terminal for mobile audio, the method comprising:
a processing step, which carries out view processing based on the signal outputted from the signal output unit;
a first detecting step, which detects plugging-in/unplugging at said input terminal for mobile audio; and
a first controlling step, which controls connection between said plurality of first signal input units and said signal output unit in accordance with a detection result by said first detection unit.

13. The operation method for AV apparatus according to claim 12, wherein
said first controlling step comprises
a connecting step for mobile audio on priority basis, which connects said input terminal for mobile audio with an output means for audio signal, which is for outputting an audio signal, in the signal output units in cases where the plugging-in has been detected in the first detection step.

14. The operation method for AV apparatus according to claim 13, wherein
said processing step comprises
a video muting step, which suspends the view processing of video signal in cases where the plugging-in has been detected in the first detection step.

15. The operation method for AV apparatus according to claim 14, wherein the AV apparatus includes
a first video display unit including a backlight, and wherein
said video muting step, comprises
an energy-saving step, which switches off the backlight upon suspending the view processing of video signal.

16. The operation method for AV apparatus according to claim 14, wherein the AV apparatus includes
a first video display unit including a backlight, and wherein
said video muting step, comprises
a reducing step for brightness, which reduces brightness of the backlight upon suspending the view processing of video signal.

17. The operation method for AV apparatus according to claim 16, wherein
said processing step, comprises
a setting step for video muting, which carries out setting as to whether the view processing of video signal is suspended in said video muting step.

18. The operation method for AV apparatus according to claim 14, wherein
said processing step comprises
a resuming step for video, which resumes the view processing of video signal in cases where the unplugging has been detected in the first detection step.

19. The operation method for AV apparatus according to claim 17, wherein:
said processing unit comprises
a setting step for cutoff of video signal, which carries out setting as to whether the view processing of video signal is suspended regardless of said detection of plugging-in, and
a setting step for video muting on priority basis, which nullifies the setting of said setting step for cutoff of video signal in cases where conflicts between the setting of said video muting means and the setting of said setting means for cutoff of video signal.

20. The operation method for AV apparatus according to claim 19, further comprising:
a switching step for video signal, which is for switching video signal of video, currently being viewed, to other video signal, wherein
said processing step, comprises
a muting step upon switching, which carries out muting of audio signal upon switching in cases where said switching unit for video signal carries out switching, and
a nullifying step for muting upon switching, which nullifies the function of the muting step upon switching so as not to carry out the muting of the audio signal regardless of the switching in cases where said the plugging-in has been detected.

21. An AV apparatus, comprising:
a signal input unit, which is for input of an audio signal from external electronic equipment through a plug;
a detection unit, which detects plugging-in/unplugging at said signal input unit;
a video display unit, which is for displaying video content information;
a sound output unit, which outputs sound based on the audio signal of the video content information, or on the audio signal inputted from the signal input unit; and
an output unit for notification information, which outputs notification information in order to carry out notification to a user based on the detection result by the detection unit.

22. The AV apparatus according to claim 21, further comprising:
a control unit comprises
control means for muting, which can control muting of display in the video display unit when the plugging-in has been detected in the detection unit, and
acquisition means for trigger signal for control, which acquires a trigger signal for control in order to control each unit, in which the control unit has a function of controlling the above units, wherein
said output unit for notification information further comprises
output means for notification information dependent on trigger signal for control, which is for outputting the notification information based on a predetermined trigger signal for control acquired by the acquisition means for trigger signal for control.

23. The AV apparatus according to claim 22, further comprising:
a switch unit, which transmits the trigger signal for control of each unit to the control unit in accordance with operation, wherein
said control unit comprises
restriction means, which nullifies the trigger signal for control, transmitted from said switch unit, other than a trigger signal for control regarding power or volume/sound during the muting control by said control means for muting

24. The AV apparatus according to claim 23, wherein
said video display unit comprises a backlight, and
said control unit comprises
cancellation means for muting of backlight, which cancels all or part of muting control of said backlight in cases where the trigger signal for control, transmitted by said switch unit, is the trigger signal for control regarding volume/sound during the muting control by said control means for muting.

25. The AV apparatus according to claim 22, wherein
said output means for notification information dependent on trigger signal for control comprises
an output device for notification information dependent on power-on, which displays notification information based on a power-on signal as a trigger signal for control.

26. The AV apparatus according to claim 21, wherein
said output unit for notification information outputs the notification information when the plugging-in has been detected in the detection unit, and there is no audio signal inputted from a plug, plugged-in to the signal input unit, for a predetermined period of time.

27. The AV apparatus according to claim 21, further comprising
a sound output unit, which outputs notification sound, wherein
said output unit for notification information outputs the notification information to the sound output unit in place of or in addition to the output to the video display unit.

28. An operation method for AV apparatus, comprising:
a detecting step, which detects plugging-in/unplugging at a second signal input unit; and
an outputting step for notification information, which outputs notification information in order to carry out notification to a user based on the detection result by the detection step.

29. An operation method for AV apparatus, comprising:
a detecting step, which detects plugging-in/unplugging at a signal input unit;
a controlling step for muting, which controls muting of display in the video display unit in cases where said the plugging-in has been detected in said detection step;
an acquiring step for trigger signal for control, which acquires a trigger signal for control in order to control each unit; and
an outputting step for notification information dependent on trigger signal for control, which outputs the notification information based on the trigger signal for control acquired by said acquiring step for trigger signal for control, and on the detection result in said detecting step.

30. An operation method for AV apparatus, comprising:
a detecting step, which detects plugging-in/unplugging at a signal input unit;
a controlling step for muting, which controls muting of display in a video display unit when said the plugging-in has been detected in said detection step;
an acquiring step for trigger signal for control, which acquires a trigger signal for control in order to control each unit;
a determining step, which determines whether the trigger signal for control, acquired by said acquiring step for trigger signal for control, is other than a trigger signal for control regarding power or volume/sound when the muting control of video display is carried out by said controlling step for muting;
a restricting step, which nullifies the trigger signal for control when the detection result by said determining step indicates that the signal is other than a trigger signal for control regarding volume/sound; and
an outputting step for notification information of nullified trigger signal for control, which outputs notification information upon nullification by said restricting step.

31. An operation method for AV apparatus, which includes a backlight in a second video display unit, the method comprising:
a detecting step, which detects plugging-in/unplugging at a signal input unit;
a controlling step for muting of backlight, which controls muting of video display by switching-off of the backlight in cases where said the plugging-in has been detected in said detection step;
an acquiring step for trigger signal for control, which acquires a trigger signal for control in order to control each unit;
a determining step, which determines whether the trigger signal for control, acquired by said acquiring step for trigger signal for control, is other than a trigger signal for control regarding power or volume/sound when the muting control of video display is carried out by said controlling step for muting; and
a canceling step for muting of backlight, which cancels all or part of muting control of the backlight when the detection result by said determining step indicates that the signal is a trigger signal for control regarding power or volume/sound.

32. The operation method for AV apparatus according to claim 29, wherein
said trigger signal for control is a power-on signal.

33. The operation method for AV apparatus according to claim 28, further comprising:
a determining step for no-signal, which determines whether there is no audio signal inputted from a plug, plugged-in to the second signal input unit, for a predetermined period of time, wherein
said outputting step for notification information outputs said notification information further based on the detection result by in said determining step for no-signal.
